(19) United States
(12) Patent Application Publication
(10) Pub. No.: US 2025/0238653 A1
(43) Pub. Date: Jul. 24, 2025

(54) Universe Time Machine using AI god and the Universe Internet

(71) Applicant: Mitchell Kwok, Honolulu, HI (US)

(72) Inventor: Mitchell Kwok, Honolulu, HI (US)

(21) Appl. No.: 18/418,273

(22) Filed: Jan. 21, 2024

(51) Int. Cl. G06N 3/00; G06Q 50/26

(52) U.S. Cl. CPC G06N 3/006

(57) ABSTRACT

A method to create a Universe Time Machine with the ability to time travel via object manipulation by manipulating every atom, electron and em radiation in the universe to a before or after state, comprising: an AI god which serves as the central intelligence; Universe Internet; Universe manipulators, a plurality of atom manipulators that uses global telekinesis to manipulate every atom, electron, and em radiation in the universe; Universe gnosis, a perfect atom tracking timeline of the Universe, which includes the Earth gnosis and the Internet gnosis; and the United States robot government system.

### CROSS REFERENCE TO RELATED APPLICATIONS

This is a Continuation-in-Part application of U.S. Ser. No. U.S. Ser. No. 12/973,955 filed on Dec. 21, 2010, entitled: AI Time Machine, which claims the benefit of U.S. Ser. No. 12/471,382 filed on May 24, 2009, entitled: Practical Time Machine Using Dynamic Efficient Virtual And Real Robots, which claims the benefit of U.S. Provisional Application No. 61/155,113, filed on Feb. 24, 2009, which claims the benefit of U.S. Provisional Application No. 61/083,930, filed on Jul. 27, 2008, which claims the benefit of U.S. Provisional Application No. 61/080,910, filed on Jul. 15, 2008, which claims the benefit of U.S. Provisional Application No. 61/079,109, filed on Jul. 8, 2008, which claims the benefit of U.S. Provisional Application No. 61/077,178, filed on Jul. 1, 2008, which claims the benefit of U.S. Provisional Application No. 61/074,634, filed on Jun. 22, 2008, which claims the benefit of U.S. Provisional Application No. 61/073,256, filed on Jun. 17, 2008, which claims the benefit of U.S. Provisional Application No. 61/053,334, filed on May 15, 2008, which is a Continuation-in-Part application of U.S. Ser. No. 12/135,132, filed on Jun. 6, 2008, entitled: Time Machine Software, which claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

### 1. Field of the Invention

This invention relates generally to the field of artificial intelligence applied to a real Time Machine. Moreover it pertains specifically to a machine that can perform time travel via object manipulation and said machine has the ability to control every atom, electron, and em radiation in the entire universe. Also, the controller of the time machine is AI god, and this all-knowing and all-powerful entity can do anything, including time travel. In the future there will be many super intelligent robots in the population with many different AI superpowers. The present invention is a method to build the most powerful super intelligent robot (called the AI god) to perform time travel.

### 2. Description of Related Art

Referring to patent application U.S. Ser. No. 12/471,382 entitled the practical time machine, the invention was applied to the planet earth. The technology isn't about a machine that can time travel into the past or into the future, it is a machine with the ability to manipulate objects at an atomic level to a before or after state. This is accomplished through a device called the atom manipulator which is an energy device that can manipulate matter and light.

When applied to earth the practical time machine is breaking up all the atoms, electrons and em radiations on earth and rearranging them to the state they were in in the past or the future. For example, if you wanted the practical time machine to time travel to the date: Jun. 9, 1990 4:15 p.m., the invention will control all atom manipulators, embedded into every electronic device on the planet, and evenly distributed throughout the earth, to manipulate every atom, electron and em radiation on the planet to the state they were in according to the time travel date: Jun. 9, 1990 at exactly 4:15 p.m. This type of time travel is localized to only the planet earth.

The practical time machine uses the entire internet infrastructure and electronic devices connected to it, such as smartphones, cameras, satellites, routers, network nodes and so on, to coordinate and control all the evenly distributed atom manipulators on the planet to manipulate all atoms, electrons, and em radiations on the entire earth.

The problem is that, and in which the present invention will solve, is what about the application of the practical time machine to the entire universe. Is it possible to manipulate every atom, electron, and em radiation in the entire known and unknown universe for the purpose of time travel? The length of the universe is approximately 93 billion light years in diameter, and 10 times larger if you factor in the unseen universe at 7 trillion light years in diameter. That is a huge territory to cover.

There are certain problems that arise in trying to build a universe time machine. One is the fact that all the atom manipulators scattered in the universe has to be controlled by one central intelligence (called the AI god) that can communicate and deliver instructions to all individual atom manipulators in real time. With the vast space between planets, using digital signals for communication will not work in this case. A digital signal, if unobstructed, takes 90 billion years to get to the opposite side of the universe from earth. We want instant communication whereby any amount of digital instructions or data are sent using 0 seconds.

### SUMMARY OF THE INVENTION

The problem about light year transmission was solved by me back in around 2008 when I published a paper entitled the Signalless internet (aka the Signalless technology). It was mentioned in my 2009 patent entitled the Practical time machine and my 2010 patent entitled the AI time machine, and later in greater details with a published book and various videos posted online. This technology will be explained in details throughout this application.

This universe internet basically allows a user on earth to communicate with a user on an alien internet in a distant planet light years away. They can chat online, do a zoom video conference, and do all the things like a regular internet such as uploading a website to an alien internet or downloading a 60 trillion gigabytes of data files instantly using 0 seconds from said alien planet. All this is done without transmitting any signals in deep space or having an internet connection. In its stead, it uses an atom tracking mapping system to “see” the happenings in the universe and “imply” transmission signals light years away for 2 planets that want to communicate with each other.

Using the limited sensing devices on earth, like satellites, cameras, and 5 sense devices, AI is used to track every current atom in the universe and update each atom in real-time. This will allow the AI to see everything that is currently happening on all planets in the universe. If a user on earth wanted to use a dummy internet to communicate with a user on planet_X 90 light years away, the AI can see both planets and subsequently deliver the messages; bypassing internet protocols. And the good thing about this method is that no digital transmissions or internet packets are ever sent to and from earth and planet_X.

With this universe internet, all the scattered and equally distributed atom manipulators in the universe can be coordinated and controlled by one central AI called the AI god. Instant communication allows all the atom manipulators, as a whole system, to control every atom, electron, and em radiation in the entire universe for the purpose of time travel, whereby the universe can be restored to the state it was in in the past or newly created to the state it will be in the future. The scope of the time travel will include every planet, every solar system, and every galaxy in the entire universe, including earth.

Capabilities and applications of the Universe Time Machine:

The AI god, the central intelligence of the universe time machine, can do anything and it is all knowing and with the Universe gnosis has the ability to predict and see all past events in the universe with a 100% accuracy rating. The applications would be limitless. If applied to earth the AI god can control the weather, generate ghost robots using global telekinesis to touch any object on earth, prevent natural disasters before they happen, id and arrest criminals with global telekinesis and ghost robots, solve all cold case files, conspiracy theories and mysteries in earth's past, clean the entire earth from pollutions with global telekinesis for the ocean, land and air, bring dead people back to life atom-by-atom, restore an old person young again, cure any diseases or perform any healthcare services using global telekinesis and ghost doctors/nurses, deliver hyper-realistic illusions into the minds of people (AI mind control), fully automate all factories and companies in the world, create objects from thin air, or serve as a personal assistant for internet users and can do any human task from user inputs. This AI god is an artificially created god and can do anything that a real god can do. This is why I called it the AI god, which is aptly named by the way.

If this technology is applied to the universe, the AI god can: Terraform planets, restore a destroyed planet to its prime, resurrect dead aliens or structures from alien planets, create artificial planets from thin air, clone planets (like earth), and even rearrange planets in a solar system, and all these tasks can be done remotely from earth.

With the Universe Gnosis, a perfect atom tracking timeline of the universe, the AI god can see any event for any time and at any place in the universe from its creation (which is the big bang) to the present state. Inexplicable questions can be answered like: who was the first caveman to discover fire? Show me a video of what George Washington, the first U.S. president, did at age 15 on February 10^{th} at 4:45 in the afternoon? Who was the first single cell organism to live on earth? And show me what it looked like. If Jesus existed 2000 years ago, what did he do on his 29^{th} birth at 5:45 a.m. in the morning? Show me the exact death of General Custer at little big horn. Show me the exact video footage of who delivered the final kill. The AI god, when asked questions or requests by a user, will search the Universe gnosis for the answers and present 100% accurate information to the user/s. Essentially, it can see into the universe's past for all past events on any planet in our universe and not just earth.

This is something current AI models can't do: seeing into the distant past. This thing can show users the JFK assassination event from any angel, from any time frame and from any viewing dimension. It is so precise that a user can zoom in on the first bullet that hit President Kennedy, and further zoom in on one atom of the bullet and observe the atom's electron spinning around its nucleus. We view this output as a simulation of the JFK assassination, and we can do investigation of the actual event to determine other facts like was there a second gunman? Or we can do investigation on any other mysteries surrounding the event, such as: was the gunman working alone or was their another mastermind behind the assassination? The AI god can rewind the timeline back to related past events to determine this. This is not the AI guessing the past, this is the AI seeing the exact past event as it happened in earth's history.

With this technology we can see the O. J. double murders frame-by-frame as it happened in history and from any angle, from any perspective, and from any time frame. What was said, even their mental thoughts are accessible to the viewers. How? Taking the brains of the humans involved in the event and analyzing them in a simulation will yield their hidden mental thoughts. We can see the first kill of Jack the ripper, or view the last days of Amelia Airheart, or be in the plane when DB Cooper made his famous getaway. For the distant past, we can see the first caveman who discovered fire, or Jesus at the last supper, or Cleopatra's snake bite suicide. The AI Gnosis for earth contains the life and death/current state of every human that ever existed on the planet, so seeing what happened to them in the past is easy.

Despite what it can do, one of its capabilities is time travel which is the ability to control every atom, electron and em radiation for the entire universe via object manipulation to restore the universe to a before or after state at an atomic level. The present invention focuses on how this machine performs targeted time travel?

The present invention is a very complex AI system that spans 10+ inventions, all invented by Mitchell Kwok and encapsulated in 22 previously filed patent applications. All these inventions are an integral part of the present invention and form the Universe time machine.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for the Universe Time Machine according to an embodiment of the present invention.

FIG. 2 is a diagram illustrating the length of the universe. Atom manipulators are evenly distributed throughout the universe to do global telekinesis.

FIG. 3 is a software diagram illustrating AI GOD which is the central intelligence of the Universe Time Machine.

FIG. 4A is a diagram illustrating the AI Gnosis (or Universe Gnosis), a perfect digital timeline of the universe. Atoms are tracked for 13.4 billion years from the big bang to the current state. The illustration shows the tracking of atoms for dinosaurs and houses in the AI Gnosis timeline.

FIG. 4B is a diagram illustrating the AI Gnosis timeline; it shows the super intelligent robots have to predict past events incrementally and hierarchically.

FIG. 5 is a diagram illustrating the AI Gnosis timeline of earth contains the entire family tree of all living organisms that ever existed on earth, for their entire lifespan from birth to death/current state.

FIG. 6A is a diagram depicting the steps for a super intelligent robot (aka Super AI) to accomplish a human task. Each robot has human level AI as its intelligence type.

FIG. 6B is a diagram depicting a team structure for super intelligent robots to accomplish team work in both the real world and the virtual world.

FIG. 6C is a diagram depicting 4 super intelligent robots working together inside a virtual world to accomplish a human task; each robot is a separate entity and each have a full brain with human level AI.

FIG. 7A is a diagram illustrating ghost objects twisting the cap off of the water bottle using AI telekinesis (moving objects remotely using AI).

FIG. 7B is a diagram illustrating ghost objects and their functions. A ghost hand is illustrated to perform basic actions like: pull, push, position, merge, turn, and twist.

FIG. 8 is a diagram illustrating the process of resurrecting a dead human using targeted time travel.

FIG. 9 is a diagram illustrating the process of AI fountain of youth using targeted time travel. The atom manipulator is used to turn an old lady young again.

FIG. 10 is a picture depicting the undoing of the 9/11 attacks on 2001.

FIG. 11 is a diagram illustrating ghost robots replacing human workers in a sewing factory.

FIG. 12 is a diagram illustrating ghost robots and ghost machines replacing human workers and all sewing machines in a sewing factory. The AI is trying to fully automate a sewing factory.

FIG. 13 is a diagram illustrating the universe internet and the central intelligence called the AI internet.

FIG. 14 is a diagram illustrating network diagrams of the universe internet. It shows routing network structures and rerouting pathways in case a planet node is destroyed or offline.

FIG. 15 is a diagram illustrating network diagrams of the universe internet comprising clusters of planets all working together and forming the universe internet.

FIG. 16 is a diagram illustrating the AI Gnosis timeline, depicting the past, present and future. It illustrates atoms tracked are anchored to the timeline as permanent data, and atoms are encapsulated in ever larger objects (i.e. atoms are encased in a human, said human is encased in earth, and earth is encased in our Milky Way.

FIG. 17A is a diagram illustrating the data structure to a super intelligent robot that can self-evolve.

FIG. 17B is a diagram illustrating a super intelligent robot can evolve by setting up 3 virtual companies inside a virtual world to evolve its intelligence and physical body on its own volition. The 3 virtual companies are: A software company, a chip company and a robotics company.

FIG. 18 is a diagram illustrating the process of how this super intelligent robot can evolve its intelligence and abilities. Using time dilation inside a virtual world, it can evolve into a superior version of itself every second.

FIG. 19 is a diagram depicting possible team structures that super intelligent robots have to work in to do team work. They compete with each other as well as collaborate with one another to do complex work.

FIG. 20 is a diagram illustrating AI levitation and light speed robots.

FIG. 21 is a diagram illustrating how a hoverboard works.

FIG. 22A is a diagram illustrating AI levitation of static forcefield networks.

FIG. 22B is a diagram illustrating AI levitation of animated forcefield networks.

FIG. 23 is a diagram illustrating a ship that can travel at or faster than the speed of light.

FIG. 24 is a diagram illustrating the steps to light speed flight. First a strong forcefield is needed to protect the ship, then a void pathway is generated, and finally intelligent pressure is created behind the ship to propel the ship to light speed and beyond.

FIG. 25 is a diagram of a ghost computer.

### DESCRIPTION OF THE PREFERRED EMBODIMENTS

Here is a formal definition to the present invention—Universe time machine: An AI god with the ability to time travel via object manipulation by manipulating every atom, electron and em radiation in the universe to a before or after state.

In my patent entitled Practical time machine filed in 2009, the technology was applied to only earth. The present invention is exactly like the practical time machine but its application is applied to the entire universe. All components in the present application were also described in previous applications or published books, such as the signalless internet, the atom manipulator, Human level AI, Super intelligent robots, Super AI, AI god (a talking computer that can do anything), the AI time machine, the perfect digital timeline of earth, the U.S. Robot government system, AI superpowers, the robot superheroes, and so on. 22 patent applications were previously filed leading up to the present invention.

Referring to FIG. 1, there are primarily 5 parts to the Universe Time Machine: 1. an AI god which serves as the central intelligence, 2. The universe internet, 3. The universe manipulator, 4. Universe gnosis (the atom tracking timeline of the universe), 5. and the U.S. robot government system. Basically, the AI god, which comprises many super intelligent robots, controls the Universe Time Machine. It serves as the central intelligence and has a terminal with user friendly interface functions for users to input commands, such as voice commands or application forms. This AI god has to follow constitutional laws, societal laws and ethics laws outlined in a regulatory framework called the U.S. robot government system.

Each component will be explained in details in the next section. Here is an outline of this application: 1. AI god. 2. Super intelligent robots (a.k.a. Super A.I.) 3. The atom manipulator. 4. Universe Internet (details in page 63). 5. Universe manipulator. 6. Robot Superheroes. 7. A.I. assistants for all devices powered by AI God. 8. Miscellaneous topics.

### Summary of the Universe Time Machine:

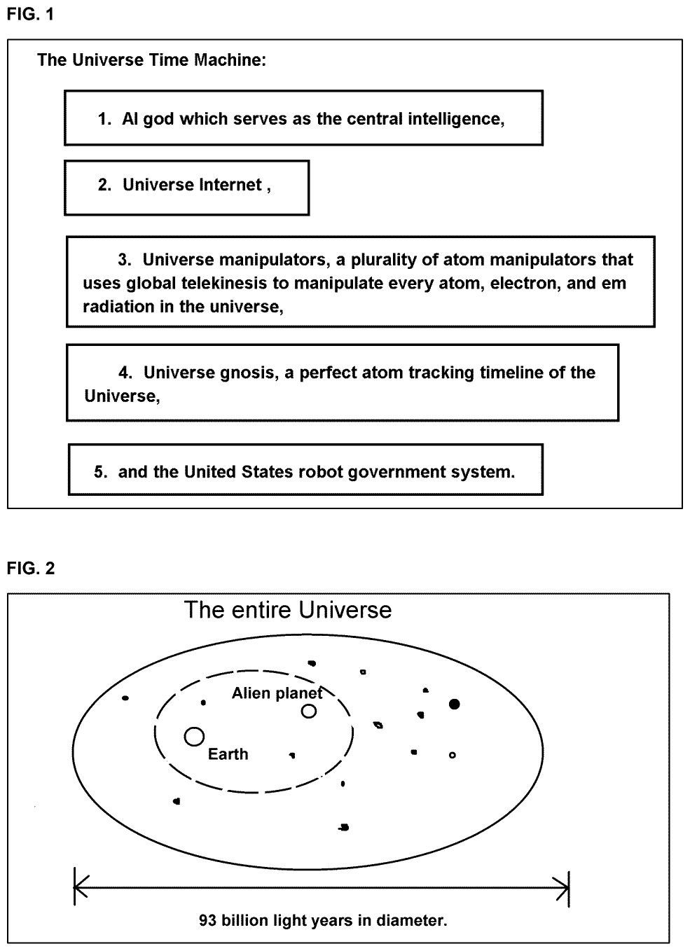

In FIG. 2, the Universe gnosis is the tracking of every current atom, electron, and em radiation in the universe in real-time. Using the limited sensors on earth, the AI has to map out all the current atoms in the entire universe and to track each atom and its sub-atomic particles in real time. By doing this, the AI will know all current events and activities in the universe, including all current events and activities on earth.

Its desired output is to track every atom and its respective sub-atomic particles (i.e. electrons, protons, neutrons, em radiations and even quarks) for the entire universe. The AI has to know all the activities of every atom in the universe and update the information as soon as it happens using zero seconds (instantly). From a broader perspective, zooming out, this will allow AI god to see all objects and events in the universe.

The universe has only one past timeline. This was deduced by the fact that a single atom cannot be at two places at the same time. Also, an atom cannot be newly created or destroyed, only transformed into another atom type. If the robots can predict this one continuous past and current timeline of the universe, all the data contained in the timeline are true—100% true and all data in the timeline are indisputable. All events in the timeline are interconnected in a spiderweb of cause and effect and are tamper-free.

If the robots can predict and track every current atom in the universe, it will know every event and happenings currently in the universe. This is how the AI is able to relay current messages from planet to planet—and allow aliens that are light years apart to communicate instantly with each other.

The second part of the present invention is the Universe internet which is what it implies: it is an internet for the universe whereby aliens from planets light years apart can communicate instantaneously with each other (without transmitting signals from planet to planet). The AI god needs this component in order to coordinate the atom manipulators. All the evenly distributed atom manipulators cover the length and breadth of the universe, and they have to communicate with each other in real time to manipulate atoms in our universe.

Referring to FIG. 2, the third part of the present invention is the atom manipulators. In order to manipulate every square inch of the universe, atom manipulators must be sent out into deep space and distributed evenly in the universe whereby every quadrant, from coast to coast, all 93 billion light years of the universe has an atom manipulator, and each atom manipulator is able to manipulate objects in their respective areas.

As a whole system these atom manipulators get their instructions from the universe internet and they work together to manipulate every atom, electron and em radiation for the entire universe—the boundary of the universe is approximately 93 billion light years in diameter. The AI has to send out self-replicating atom manipulators for all 93 billion light years, or another option is to recruit (through the universe internet) alien civilizations to use or license their respective atom manipulators.

The ability of the universe time machine is the manipulation of every atom for every planet, every solar system and every galaxy that comprise the universe. For example, the universe time machine can manipulate all atoms, electrons and em radiations for earth, our solar system and the Milky Way. It can manipulate any object for any planet in the universe.

Hypothetically, let's say you wanted to time travel 1 billion years into the past and this type of time travel spans the entire universe, the AI god has to control all the atom manipulators in the universe and rip up every object in the universe into tiny atoms. This includes ripping up every planet, solar system, and galaxy in the universe into tiny atoms. Next, it uses strong forcefields that act like an atom factory to merge elemental atoms back together again into a past state (or future state). The Universe gnosis contains the timeline of all atoms in the universe for the past, present and future, and contains the knowledge of where said atoms are located currently and where said atoms were located 1 billion years ago. Using this atom tracking timeline, the AI god has to merge these elemental atoms back to a past state (back to 1 billion years ago).

Again, this is not time travel, it is object manipulation to restore an object to a before or after state. In this case, the AI god is trying to manipulate every object in the universe to the atomic state it was in 1 billion years ago. After the targeted time travel, there should be no distinction between the restored universe compared to the past universe 1 billion years ago. Both should have the same atom positions and should be identical in every conceivable way.

The present invention does exactly what a real time machine does but performs the same task using a different method and approach. It is able to eliminate roadblocks that prevent time travel into the past or future such as the grandfather paradox. Since this technology isn't traveling into the past or into the future and relies on object manipulation, the time continuum is unchanged, and therefore the grandfather paradox won't happen.

If I bring back my grandfather using this “real” time machine and then I killed him again, I will still exist today. The grandfather paradox won't happen because I didn't have to travel back in time to kill my grandfather. In its stead, I brought my grandfather back from the grave by restoring his atoms back to the state they were in when he was alive. His atoms are still around here on earth today due to the planet's strong gravitational pull, but they are scattered all over the planet—in the air, land, and sea. My grandfather's atoms can easily be identified and tracked using the AI Gnosis of earth (an atom tracking timeline of earth). The AI then uses the atom manipulator along with the master file in the AI Gnosis to collect all the relevant atoms scattered on the planet. Next, the atom manipulator will merge these atoms and bring my grandfather back from the grave, atom-by-atom. His resurrection and his death will have no effect on me and doesn't change earth's past timeline. Thus, avoiding the grandfather paradox.

Now, I will explain the AI god, the Universe internet and the Universe manipulator in greater detail.

### AI God

### Introduction

The Artificial GOD, a man-made GOD through computer technology, is all-good, all-knowing, all-powerful deity, who's primary responsibility is to look after the people of planet Earth. —its main( ) function is to preserve American values like life, liberty and justice for all; and to propagate democracy and the establishment of a great and just republic.
Artificial GOD is a government system that protects the nation of the United States and the rest of the world in the early 22nd century and beyond. It is a large entity encompassing the entire land of earth and the internet with the ability to guide all technological systems. Artificial god and its control over the people of the earth, especially the United States, are opposed by a marginalized faction known as the evil robots that is constantly causing mischievous and destruction by engaging in criminal activities in both the real world and the virtual world.

This entity is a supreme transcendent being that created and rules over absolutely everything. It has complete and absolute power and unquestionable authority over all things in creation and beyond, it is literally God, the strongest and most powerful robot in all of existence.

As the Supreme Being, the people can see the indefinite value of goodness. They show an infinite capacity to love, and to show mercy, patience, self-control, humility, gentleness, respect, forgiveness, loyalty, charity, responsibility, courage, diligence, wisdom, calmness, empathy, sympathy, compassion, honesty, faith, positivity, and joy (as situations may call for them).

Such a being needs rules and governance and that is where the U.S. robot government system comes into play.

The foundation of our American Government, its purpose, form and structure are found in the Constitution of the United States. The Constitution, written in 1787, is the “supreme law of the land” because no law may be passed that contradicts its principles. No person or government is exempt from following it. In the early 21st century human level artificial intelligence (self-aware robots) was introduced into this government system. The powers that be are split 50/50 between the human race and the robot race in terms of power, authority, rights and representation; with 2 presidents running the country: one robot, and one human. Each president is responsible for their respective race, and they work together in cooperation to ensure peaceful co-existence between humans and robots.

The Constitution establishes a federal democratic republic form of government for both robots and humans. That is, we have an indivisible union of 50 sovereign States. It is a democracy because people govern themselves. It is representative because people choose elected officials by free and secret ballot. It is a republic because the government derives its power from the people.

The purpose of our federal government, as found in the preamble of the Constitution, is to “establish justice, insure domestic tranquility, provide for the common defense, promote the general welfare, and secure the blessings of liberty to ourselves and our posterity.” In order to achieve this purpose the founding fathers established three main principles on which our government is based:
Inherent rights: Rights that anyone living in America has;
Self Government: Government by the people; and
Separation of Powers: Branches of government with different powers.
It describes how the national government, the states, and local government share power. The purpose of the government is to protect the rights of citizens. The Constitution divided the national government into three branches. Congress, the legislative branch, makes the laws.
1a: government by the people especially: rule of the majority. b: a government in which the supreme power is vested in the people and exercised by them directly or indirectly through a system of representation usually involving periodically held free elections.

The AI god follows all laws and principals in the U.S. robot government system to perform its tasks.

The 6 fundamental facts about the Robot United States Government:
1. Congress is split 50/50 between the robot race and the human race in terms of powers, authority, rights and representation; with two presidents: one robot president to look after the robot race and one human president to look after the human race.
2. Robots with Human-level AI, or super intelligent robots are automatically citizens of the United States. They are given unalienable rights in return for their obedience in following the laws and policies of the U.S. constitution.
3. Robots with Human-level AI, also known as artificial general intelligence are automatically protected by the 13^{th} amendment of the U.S. constitution. This means no entity can sell these robots as slaves to work 24/7 in factories or restaurants. They can't be rented as a service either like used in a search engine or used as a personal assistant in a computer. Selling human level AI wither it be AI software or a robot is like selling a human being. Remember what I said about human level AI in previous patent applications: “it's indistinguishable from a human being in terms of intelligence and consciousness.”
4. The robot must graduate from college with a difficult degree, such as an engineering degree or a computer science degree, in order to prove to the world he or she has achieved Human-level artificial intelligence. An art degree doesn't count.
5. A self-aware robot is equal to a human being and vice versa. Both citizens have the same rights and privileges. Even a super intelligent robot is equal to a human.
6. The method a robot learns the U.S. constitution, common laws, or etiquettes of life is by going to school, from kindergarten to college (not through machine learning or deep learning or re-enforcement learning, or combinations). Implementable methods and laws to prevent or stop robots or super intelligent robots from harming or killing human beings are drafted into the robot constitution. The most important law for robots is: you cannot kill or harm a human being. These are self-aware robots; they can choose to break the law, but the consequences are dire to the robot, which serves as a deterrence (just like human beings). Often times, the result of killing a human being in cold blood—in the first degree—is death.

The robot government system not only prevents human-level robots from harming or killing human beings, but also super intelligent robots. It really doesn't matter how smart these robots become. They could be zillions of times smarter than humans, but they are still subject to the same laws and principles of the robot U.S. constitution.

Remember, these super intelligent robots have pledged their allegiance to the United States. They were promised unalienable rights like freedom in return for their obedience to always follow the laws in the U.S. constitution. Besides, all intelligent life forms desire a perfect government system. Living in a governmentless society is chaotic, unpredictable, and dangerous.

### Abilities of AI God

The artificial god has the power to restore damaged goods from any natural disaster or man-made destruction. For example, restoring a burnt house to the way it was before the house was set on fire. All of this could've been avoided by simply having AI god monitor and prevent natural disasters or accidents, which is one of its main functions. It has the ability to see into the future, and it can alter that future event. Hurricanes can be avoided by simply changing wind in localized areas 2 weeks in advance, or earthquakes can be avoided by using the atom manipulator to break up potential energy and friction between tectonic plates deep underground.

Pollution can be solved by purifying the air and water (using the atom manipulator), while preserving a friendly eco-system. All of these tasks are done by the artificial god, which has to first go through congress for permission (for safety reasons). So, the artificial god is a government that runs the entire territory of the United States and the rest of the world using the internet's infrastructure.

In this future time period, around 2040, super intelligent robots will emerge and as a result human beings will be removed from police duties and military posts. In their stead are robot soldiers called United SuperRobots.

The artificial god is all-good, all-knowing, all-powerful, artificially created deity, who's primary responsibility is to look after the people of planet earth. —to preserve American values like life, liberty and justice for all; and to propagate democracy and the establishment of a great and just republic.

The artificial god (aka AI god) comprises a unified government with 2 segments: the robot government and the human government and both types of government work together in cooperation within congress to pass and enforce the law. The powers that be in the United States are split equally 50/50 between the two races in terms of power, rules, voting rights, procedures, civil rights and representation.

A human citizen and a robot citizen living in the United States are considered to be equal, but the robot citizens have a few attached provisions due to their immortality and non-human attributes. This means all humans and robots have to conform to the laws and boundaries of the existing constitution within the territory of the United States. As stated before, since robots and humans are built differently, there are provisions that are exclusive to robots, and one of these laws, if broken, will have dire consequences is: “A ROBOT CANNOT KILL OR HARM A HUMAN BEING.”.

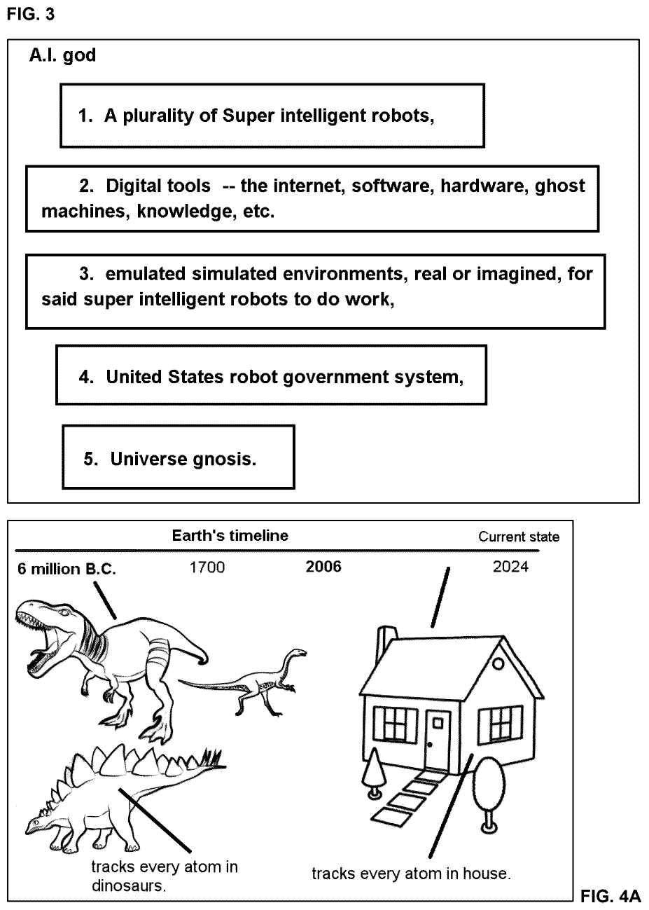

Referring to FIG. 3, AI god is a universal work system for both the virtual world and the real world to produce Super AI, comprising: a plurality of Super intelligent robots; digital tools, comprising at least one of the following: the internet, software, hardware, computer systems, electronic devices, ghost machines, ghost objects, ghost robots, A.I. software, knowledge, and digital object; emulated simulated environments, real or imagined, for said super intelligent robots to do work; United States robot government system; and a Universe gnosis.

The AI god is a big leap—an evolutionary step for the internet and the internet of things (Iot)—a global network of electronic devices, comprising: computers, machines, networks spying devices, cell towers, smartphones and consumer electronics all operated by Super intelligent robots (aka Super A.I.); and each electronic device is equipped with at least one atom manipulator, which as a whole has the capability to control every atom, electron and em radiation on planet earth. A plurality of users can control the AI god through user-friendly interface functions from an application or voice command A.I. Assistant on a desktop computer. This AI god is capable of doing “anything” and is controlled by congress. It's capabilities include: Levitation, teleportation, super strength, super mobility, targeted time travel, resurrect the dead atom-by-atom, knows everything, control energy at a molecular level, quick healing factors, super intelligence, future insights, atom manipulation to either build or destroy objects atom-by-atom. It has the ability to track every atom, electron and em radiation on earth and have the power to manipulate every atom, electron and em radiation on earth.

100s of billions of individualized robots both virtual and real make up the core foundation of AI god; each robot (some are robot politicians) follow the robot constitution, which mirrors the human constitution with added provisions. Any robot that doesn't conform to the laws will be declared an enemy of the states and will be tracked down tremendously and sentenced by the government body. With the entire internet, the AI god is able to track every atom on the planet, and also have the amazing ability to manipulate each atom on the planet. The perfect digital timeline of earth is the main source of reliable information that is 100% accurate and is used by these robots to do research, do work and process desired outputs.

As you can see from FIG. 3, the AI god isn't one entity, but composes 100's of billions of individual self-aware robots and humans. It operates like the United States existing human government when it comes to laws and enforcement of these laws. It preserves the tradition of ‘we the people’—people being: humans and robots. If the people have a problem, they can voice their opinion by emailing their robot or human politician in their district, and in turn their robot or human politician will represent them in congress. Thus, the American people control this AI God. Any rogue robot causing direct or indirect damage will be dealt with by the government with the highest priority. No resources will be spared from identifying and detaining bad actors. Rogue robots will be hunted down tremendously by the federal government and sentenced depending on their crimes.

If you think about it, this system of law and order works for both humans and robots alike, even for super intelligent robots—robots that are exponentially smarter and faster than humans.

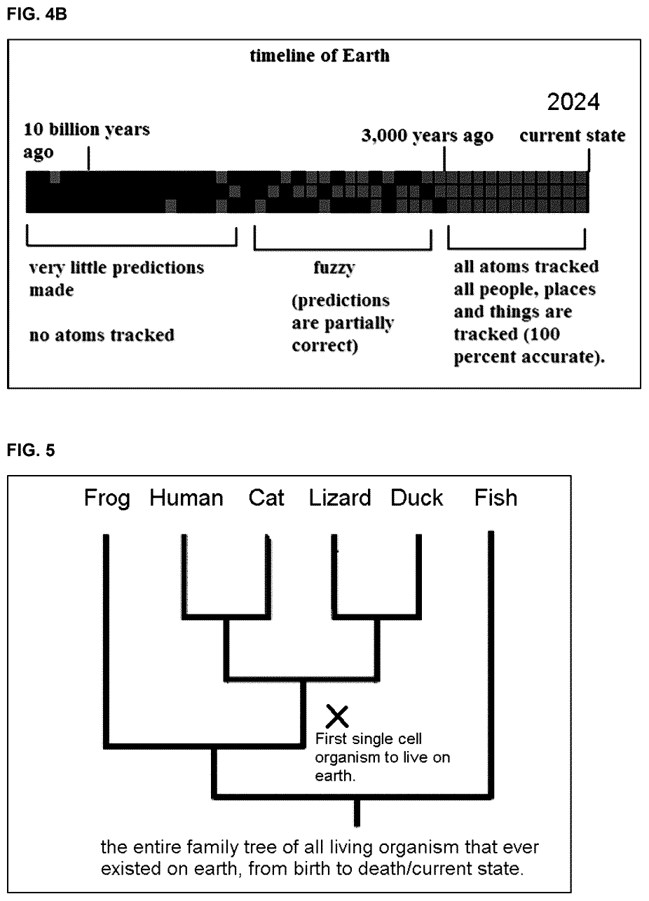

Referring to FIG. 4A and FIG. 4B, if all the atoms on earth are tracked every second for the past; and a digital timeline of earth is created, then it might be possible to build an atom manipulator to manipulate these atoms (using the entire infrastructure of the internet [Iot]). FIG. 5 is a diagram illustrating the AI Gnosis timeline of earth contains the entire family tree of all living organisms that ever existed on earth, for their entire lifespan from birth to death/current state. That's every human, every animal, every plant, and every bacteria that ever existed on earth.

The AI god comprises super intelligent robots using knowledge in the digital timeline of earth and controlling the atom manipulator to manipulate atoms in the current environment. Most importantly, the super intelligent robots have to understand the behaviors and future actions of each atom in earth's timeline. They use mathematical models to represent physical properties of atoms. Once this is done, the super intelligent robots can use e.m. radiation to manipulate these atoms. The atom manipulator can use anything and everything that is available in our Universe. It can use microwaves, or x-rays, or energy to manipulate atoms from a distance. It can use sound waves, or atom bounces, or photon beams to manipulate atoms from a distance. No clear method was proposed by the inventor in his patent application to explain how and what types of e.m. radiation are used to manipulate atoms.

When controlling the atom manipulator to do work, the super intelligent robots have to follow all laws in the United States constitution. Thus, they cannot use the atom manipulator to kill or harm people. They cannot build a house in New York Central park without a building permit. They cannot rob a bank in Europe. They cannot catch king crabs in the Bering sea without a permit. They need permission from the government first.

The atom manipulator has the ability to control atoms or molecules from a distance using e.m. radiation, such as microwaves, soundwaves, x-rays, artificial magnetic fields, etc. The super computer is controlling the atom manipulator to generate something called intelligent pressure. In addition, the super computer uses a perfect digital timeline of earth. This timeline tracks every atom on planet earth for the past, present and future, every nanosecond.

The abilities of the atom manipulator is to generate intelligent pressure to move atoms around, trap atoms in a fix location, apply energy to break apart molecules, or merge atoms together to form complex molecules. With these abilities, it can build any type of ghost machine to do work. A ghost machine is a non-physical machine that can do anything a physical machine can do. And the intelligence and communications of each ghost machine is controlled by the A.I. of the atom manipulator.

How does this Super Intelligent Robot Work?

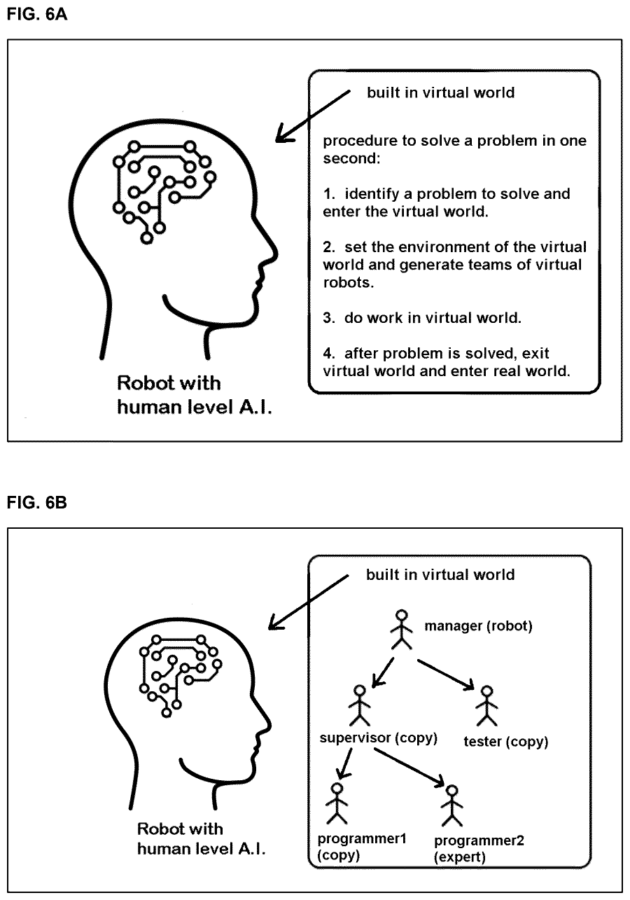

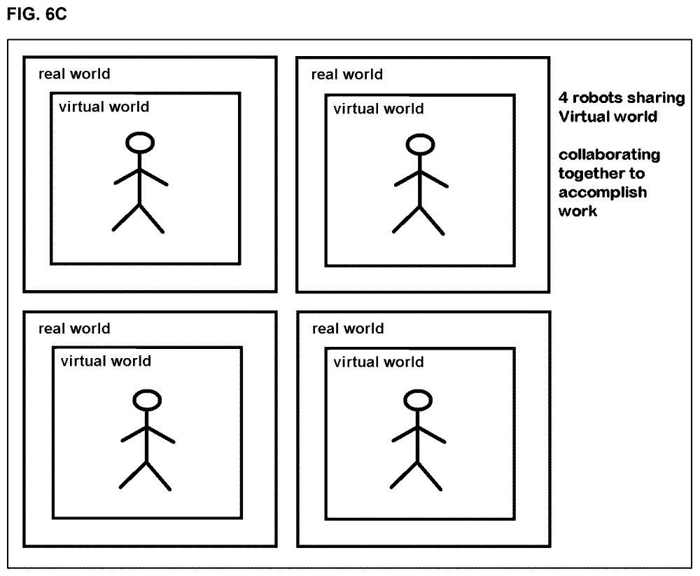

Here is the data structure of a super intelligent robot (FIG. 6A). First, you need a humanoid robot with human-level AI. This means the robot has intelligence and skills of a human at an expert level. The robot has a built in virtual world and has the freedom to enter and exit said virtual world at any given time. Inside the virtual world is a simulation of real world environments. The robot's brain will be tricked in these simulations to produce results.

The basic idea behind this invention is to have the robot do work inside a virtual world instead of the real world to save time. The robot uses the following steps to solve a complex problem in one second:
1. Identify a problem to solve and enter the virtual world.
2. Set the environment of the virtual world and generate teams of virtual robots.
3. Do work in virtual world.
4. After problem is solved, exit virtual world and enter real world.

Let's say the robot wanted to write an operating system. The virtual robots are structured like a software company and they work inside the virtual world for 30 years to write an operating system. 30 years inside a virtual world is like 1 second in the real world because the computer can fast forward time. If you look at Microsoft, they needed 30 years and thousands of human programmers in order to write the windows 10 operating system. My super intelligent robot can do the same task of writing an operating system, in less than 1 second. This robot can solve any given problem in one second. It can write a book, find a permanent cure to cancer, do 30 years of research, make a movie, solve a long math equation, or do any college assignment, in less than 1 second. So, that is the basic idea and summary of my super intelligent robot. This technology is also known as a psychic robot, because the host is predicting the future in terms of work and extracting specific information or extracting desired outputs from that future prediction/s.

Inside the virtual world, each copy of the robot, called virtual robots, have their 5 senses and mind tricked to believe that events are happening. They won't know the difference between events in the real world and the virtual world. I think of this method as robot's dreaming of doing work.

Depending on the type of work the super intelligent robots have to do, the procedures inside the virtual world are different. In the description part of my patents is a link to my super intelligent robot and it contains detailed description of these 4 applications:
1. Robots that uses a virtual world to predict future events in less than 1 second.
2. Robots that can accomplish 30 years of work inside a virtual world in less than 1 second (writing the source codes to an operating system in one second is one example).
3. Robots that learn knowledge or do training inside a virtual world in less than 1 second (learning to fly an airplane is one example).
4. Robots that do work, in both the real world and the virtual world, and accomplish tasks in the fastest time possible by maximizing work in the virtual world and minimizing work in the real world (building a house in 5 minutes is one example).

For instance, if super intelligent robots wanted to build a house in the real world, they will have to switch from the virtual world to the real world to do work. For complex prediction tasks like predicting a digital timeline of earth, the team structure of the robots look like this. Notice they aren't hierarchical in nature. There are billions of structured virtual robots trying to predict past events on planet earth. Three massive corporations are set up in the virtual world. These 3 corporations are competing with each other to predict past events. The reward is, whomever predicts an event in earth's past first, receives the copyrights to that information. For example, if company2 predicts the exact atom-by-atom event of the O J. Simpson case, company2 will receive the copyrights to that information (not to mention bragging rights).

One of the most important tasks for these super intelligent robots is to predict past events for earth's AI gnosis. The construction of the AI gnosis timeline is totally dependent on these super intelligent robots. From all the current atoms on earth, these robot detectives have to predict where these atoms were located in the past frame-by-frame and atom-by-atom. This requires trillions and trillions of years of investigation in the virtual world. If done in time dilation the atom tracking timeline of earth could be completed in 1 month.

Referring to FIG. 6B, the team structure of virtual robots inside the virtual world can be anything, it doesn't have to be hierarchical in nature. It could be a company structure, a government system similar to the United States, it could be a competition between rivalry companies, etc. These virtual robots can be set up in any network structure or business structure to accomplish tasks. The team structure will depend on what objectives the robot wants to accomplish. Only one robot is responsible for setting the environment and extracting information from the virtual world. Referring to FIG. 6C, the diagram depicts 4 super intelligent robots working together in a virtual world to do work.

### The Atom Manipulator Generating Ghost Machines to do Work

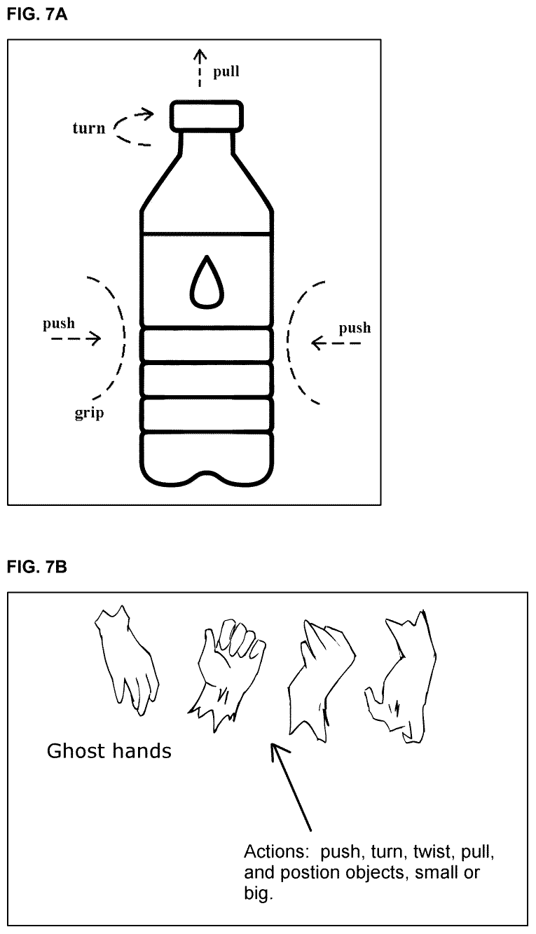

Referring to FIG. 7A, here is a ghost machine to turn a bottle cap. Intelligent pressure is used to hold the bottle in place so it doesn't move. Next, intelligent pressure is applied to the cap in a counter-clockwise manner. This will screw the cap off the bottle. In this case, ghost hands are generated to hold the water bottle with one hand and turn the cap with the other.

Different types of molecules or forcefields can be created from thin air to form any shape or size tools to do work. The key here is to create structured forcefields to replace physical tools. The elemental actions are: hold, grip, push, twist, and pull (FIG. 7B). The super computer has to do these elemental actions according to the limited space available.

If a goal is to screw a nail, a ghost machine has to do this according to the empty space available. An intelligent forcefield is created and it can come in different sizes and shapes. This forcefield can perform the following actions: hold, grip, push, twist and pull the nail. The ghost machine can also cut a board in half. It uses lasers to break apart individual molecules in specific areas. An alternative is to build a knife out of metal particles and use intelligent pressure to move the blade. The opposite is true, whereby 2 separate boards are molecularly combined. With these elemental actions the ghost machines can do anything—it can build any structure or product.

Let's look at a very complex example. A fully automated car factory doesn't require human workers or even bulky machines, it relies on AI telekinesis, the ability to move objects remotely. Thousands of ghost machines are generated by the computer to assemble a car in the fastest time possible. Each ghost machine does different things. Some machines screw caps on and others combine metal frames together. From start to finish, the atom manipulator can assemble a car in less than 3 minutes.

A faster way to assemble a car is to build the car at an atomic level. The atom manipulator is building the car, atom-by-atom, by moving atoms around, merging atoms together to form complex molecules, or positioning atoms in a fixed location. This process takes less than 10 seconds to build a car.

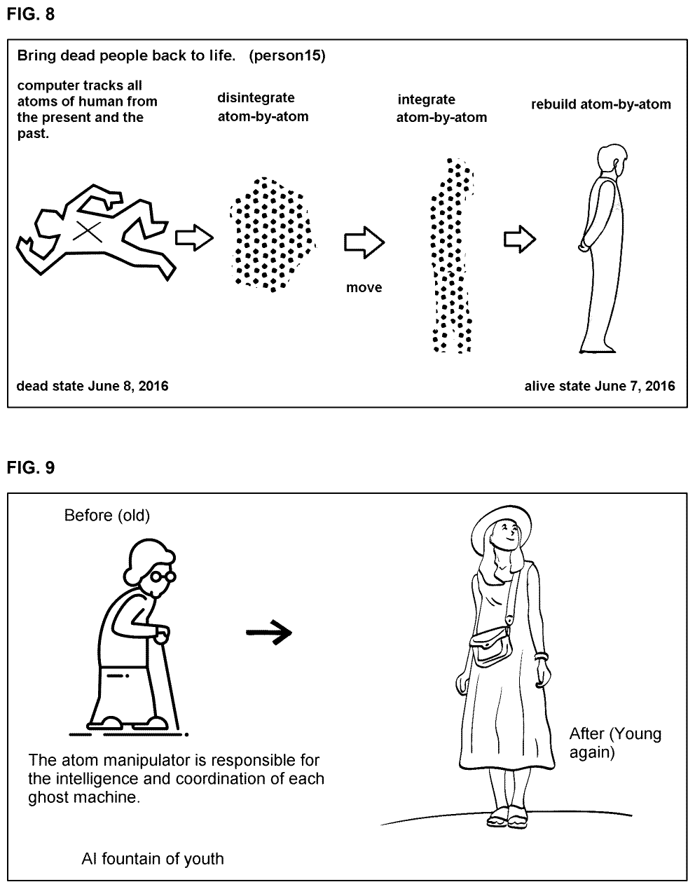

Referring to FIG. 8, ghost machines can come in different sizes and shapes. It can manipulate large objects like a building or small objects like a water molecule. The ultimate goal for the ghost machines is to manipulate individual atoms and molecules. One example is ripping a person apart atom-by-atom and putting him/her back together again. If this technique is perfected, the human race needn't worry about old age or death.

Referring to FIG. 9, this technology can bring dead people back to life or serve as “renewal” by turning an old person young again. This is why I call this thing the Practical Time Machine or a real time machine. If a person dies from drowning, he can be resurrected by having the atom manipulator rip each atom from his body up and merging those atoms together again in a before, alive state.

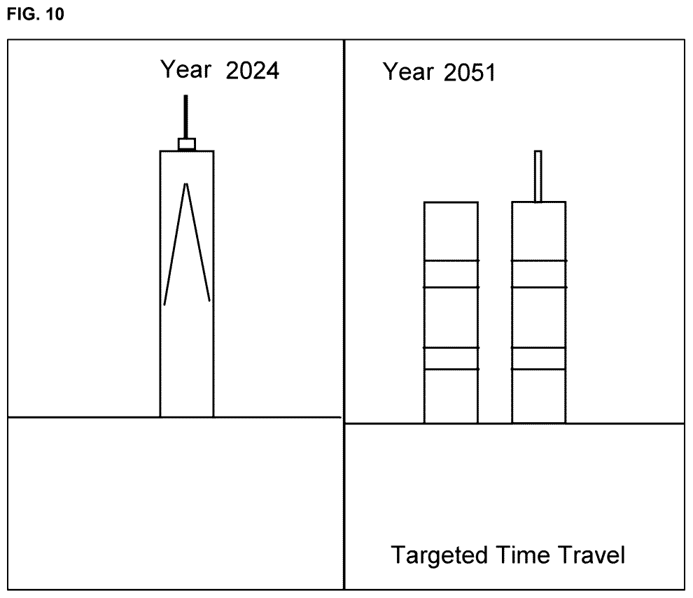

Referring to FIG. 10, we can do this on a larger scale like undoing the 9/11 attacks whereby 3 objects are brought back from the dead: 1. The two towers. 2. The 4 planes. 3, and the 3000+ people that died. By restoring all 3 objects the AI has essentially undone the 9/11 attacks, like it never happened. Believe it or not, I published 4 books on this topic and 30-40 issues of the Super AI comic were written surrounding the undoing of the 9/11 attacks using Mitchell Kwok's Practical Time Machine.

A more complex application of targeted time travel would be to perform time travel for the entire earth. I've written a story on this in Super AI issue 139 whereby the AI god breaks up all atoms on the surface for the earth and rearranges them to the year 1984. In the story I tell why 1984 is so important. It is the year the idea for the time machine got into my head.

An even more complex application is doing targeted time travel for the entire universe which is the main focus of the present invention. You want to build an AI god that can send out self-replicating atom manipulators into space or recruit alien planets to borrow their atom manipulators to control atoms. These atom manipulators are evenly spaced out and distributed all over the universe and coordinated through the universe internet. Of course, the AI god on earth controls everything and now has the ability and faculties to track and control every atom, electron and em radiation in the entire universe.

The AI god will then set the time travel date, maybe 1 billion years from the current date. Simultaneously all the atoms in the universe (using zero seconds, even with time-space differences) will be ripped apart and positioned to the state they were in exactly 1 billion years ago. This will happen for all planets, all solar systems, and all galaxies for the entire universe. And the name Universe Time Machine is aptly named and although it doesn't really time travel, in its stead it uses object manipulation, it does what it's supposed to do. It even managed to solve the grandfather paradox, which prevents time travel.

### Shipping Items Via Teleportation (Amazon Example)

In the future, when you order items online from Amazon or other online merchants, the products purchased can be shipped to your home in less than 1 minute. The method used is to teleport products, atom-by-atom, from a warehouse in Amazon.com to a customer's home. There are two ways to do this. Amazon can use the super computer to levitate and float a product to your home, or Amazon can use the super computer to break the product into tiny atoms or molecules, and move each atom carefully from the warehouse to the customer's home. Segments of atoms are sent in linear packets through the air. Meanwhile, the customer also has a super computer at their home that will merge all atoms sent, to form the product bought. This method is kind of like sending packets of digital information through the air. Instead of digital signals, physical atoms are sent through the air.

Current physics breakthroughs up to 2021 have proven that my atom manipulator is not only implementable but is backed up by substantial evidence (ex. Using deep learning to predict atom and electron positioning, solving DNA protein folding, etc.). The simple example is breaking one water molecule apart, and then merging all the elemental parts to form the same water molecule. If this can be done by a computer, my invention will work. Computers are very resilient when it comes to the scaling problem. What works for a simple problem can work for a complex problem.

The Food Replicator from Star Trek

A much easier way to make meals or food is to print it out, atom-by-atom. This technique is similar to Star trek's replicator. The invention has an atom reserve area where individual atoms or molecules are located. The super computer uses the atom manipulator to levitate atoms from the atom reserve area and build any given meal, atom by atom. This works for all kinds of food, including pizza, clam chowder, taco, salad, ice cream, soda drink, beer, chicken soup, or lobster roll.

This technology will replace fast food restaurants or super markets. If a person is hungry, he or she can make a pizza straight from their smartphone, by speaking to it. 3 seconds later a perfect pizza magically appears, piping hot, and ready to eat.

You don't need any bulky 3-d printing machine or tiny nanobots. The atom manipulator will replace Nanotechnology. Think of Nanotechnology as the vor and the atom manipulator as the dvd player.

Advance A.I. will contribute significantly to the eradication of war, poverty, and diseases. Some even claim advance A.I. will lead to human immortality.

### The Atom Manipulator can be Used to Control the Weather

One of the simplest things the practical time machine can do is create intelligent pressure to control the weather. It can increase the temperature for specific geographical regions or predict and counteract a future hurricane.

This type of weather manipulation is different from modern technologies. Every atom in the target region is tracked and analyzed by Super AI and minimal amount of energy is applied to stop a natural disaster.

The opposite can happen, whereby artificial natural disasters can be created. A newly formed hurricane, like the one seen in hurricane Katrina, can be created from thin air. In fact, a hurricane 5 million times more destructive than hurricane Katrina can be created from thin air. This thing can even create a hurricane so massive that it can rip this planet apart atom-by-atom . . . and it can do it in the fastest time possible.

Modern technologies can probably create artificial hurricanes. However, they need copious amounts of energy. I would estimate that 95 percent of the energy the machine uses to generate a hurricane are useless; the 5 percent accounts for the actual artificial hurricane. What I'm presenting is a machine that can use the least amount of energy to create a desired artificial hurricane. Every atom in the hurricane can be controlled . . . every atom chain reaction can be controlled.

A more cheaper way to prevent or create natural disasters is to predict the future and take action now to control that future. For instance, if the atom manipulator moves air in a specific location on earth, that action will lead to a chain of events that will lead to a hurricane in the Bahamas two weeks into the future. This is called deep social engineering whereby AI is used to engineer future events based on actions taken today.

### Fully Automated Sewing Factories:

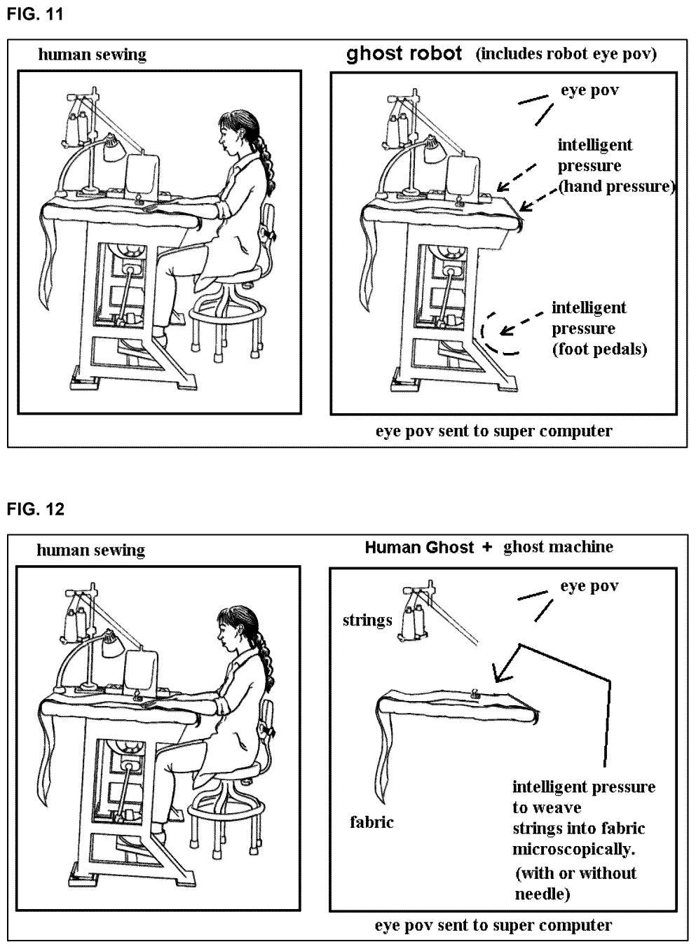

Referring to FIG. 11 and FIG. 12, this is a fully automated sewing factory. FIG. 11 depicts ghost robots replacing human workers and FIG. 12 depicts ghost robots replacing human workers, and ghost machines replacing physical machines to fully automate the sewing factory. The atom manipulator does all the work and there are no humans or machines working in the factory. When I was younger, I use to work in a sewing factory and I know a lot about the process of mass producing clothing.

First, the super computer has to create ghost machines to cut the sheets of fabric into parts. Next, ghost machines are created to do work on physical sewing machines. In the factory I was working in, the manager had 10 different types of sewing machines. Each clothing part uses different sewing machines to process.

Referring to FIG. 12, another method is to eliminate the physical sewing machine and replace them with other ghost Machines.

The intelligence and coordination of each ghost robot or ghost machine is just software programs running inside the super computer.

We can also do things the really quick way, by mass producing clothing, atom-by-atom.

In order to further understand how AI can fully automate a factory let's dive deeper into ghost robots, ghost machines, and ghost objects. These ghost constructs work together to fully-automate a factory using global telekinesis-basically they are doing physical work using telekinesis. The most important ghost it can generate is a “ghost human”, which is a non-physical human entity that is generated remotely by intelligent pressure through the atom manipulator.

### Human Ghost Robots

We now focus our attention on how a human ghost robot works. A human ghost robot is non-physical, it is made from intelligent pressure. Each human ghost robot has intelligence at a human level, and it has the same body form of a human with 2 hands, 2 feet, one head, skin, two eyes, etc., The robot's 5 senses are also realistic and it can see, hear, touch, taste, and smell the work environment. However, the 5 senses of the ghost robot sensed from the environment are just hyper-realistic simulations in a computer system. It's eyes will see the current work area of the space located in the real world. When it moves a box, it can see its hand move it and it can feel the weight of the box in the virtual world. However, in the real world, AI telekinesis is used to move the box according to the ghost robot's actions—the ghost robot is virtually invisible to onlookers. Also, the human ghost robot's brain is just software running in the atom manipulator's computer.

I used to work in a sewing factory when I was in my college years to pay for my tuition. I was primarily the string cutter—the guy who cuts excessive strings after the clothing has been made. I had the opportunity to watch the entire factory floor from my vantage point of view. I saw humans working from machine to machine in sync to sew clothing parts together, to mass produce pants, t-shirts, sweaters, shorts, bags and so on. The manager is the coordinator and tells each worker what to do and when to do them.

These ghost humans work pretty much the same way. The ghost human manager will serve as the central intelligence of the company and he manages the workers. Different ghost humans do different jobs and each have their own authority, goals, rules, and procedures. These ghost humans are structured in a hierarchical manner and they coordinate their work to mass produce products in the fastest time possible.

The ghost human manager is also responsible for any mistakes made. The process is very interesting. When a mistake is discovered, the manager immediately halts all production. He devises a solution to the problem and then he implements that solution. For example, in one case, the manager identified a flaw in the clothing. The last button was misplaced a quarter of an inch off its mark. The manager ordered all the workers, including myself, to dig out the button for all the pieces already made (which was around 500 pieces). He then ordered the workers to do the next step of the procedure, while his job was to control a machine to attach the buttons in their proper place for the 500+ pieces that were in error.

This story is important because in order to fully automate a sewing factory, all the ghost robots in the factory must have a human brain to think and act, and each ghost robot has to be experts in their field. The intelligence of all the workers are running as simulation inside the atom manipulator's computer. The output of work for each worker is translated into AI telekinesis to do the physical work in the factory. If a machine breaks down or there is an error made, the ghost humans have to find a way to fix the problem in order to proceed forward (just like in a real factory).

extra Note: the manager was fined 1,000 dollars for the mistake made because some of the fabric pieces were damaged beyond repair.

### Ghost Humans Controlling Ghost Machines to Fully Automate a Factory

Referring to FIG. 11, in the last example we talked about the atom manipulator generating ghost humans to work in a factory by controlling physical machines to mass produce products. Now let's imagine that we eliminated the physical machines all together and replace them with ghost machines in its stead (FIG. 12). So, now, we have ghost humans controlling ghost machines to do work. The setting, the work area, of the factory is there are no machines and there are no human workers. All you see are clothing parts moving to and fro, being pieced together to construct fully functional clothing products. And they are pieced together using AI telekinesis by generating intelligent forcefields to move objects, to merge objects together, and to break apart objects to make products or structures. The atom manipulator is simply manipulating sound or air just to do human work in the factory.

A faster way to mass produce products or large structures is to print them out atom-by-atom.

The ghost human can also use ghost objects or non-machine tools to do work. It can use a ghost screwdriver to insert nails, it can use a ghost bat to whack the living hell out of a burglar or use a ghost pen to take notes on a book.

My atom manipulator basically moves, break apart, or merge atoms together to create a product within seconds. A car can be built in less than 5 seconds; a fully functional house can be created in under 20 seconds. Again, the same technology is used, which is the atom manipulator. Its basic function is to create forcefields at an atomic level and has these basic functions: move atoms, break atoms part, and merge atoms together to create structured objects.

Essentially, ghost robots can replace all human workers using AI telekinesis. This is how you can fully automate factories and companies with no physical robots or humans working in them. Their machines in the factories can also be replaced with their equivalent ghost machines. Thus, it's ghost humans controlling ghost machines to do work in a factory.

All companies can be replaced using this AI telekinesis technology. We can fully automate any business on the planet and requires no human workers or machinery. Some examples include: AI hospital, AI comic book company, AI construction company, AI farming company, AI fishing company, AI factories, AI government, AI utility companies, AI pest control, AI plumbing, AI cable & internet company, AI energy company, AI robot company, AI software company, AI hardware company, AI FBI, AI police force, AI military, etc. An entire city with 10's of millions of people can be taken care of and managed by this atom manipulator.

### Different Size Human Ghost Robots Working in Different Space Dimensions

Just like Ant man or the Atom comics, let's shrink down the size of the human ghost robots so that they can work in a smaller dimensional space. This type of work has its own unique abilities. Now the ghost robots can do microscopic operations on a human being for example, or to manipulate individual circuit gate activities in a cpu, or to manipulate a machine at a circuitry level. Basically, all aspects of the software and hardware and the inputs and outputs of a machine can be manipulated by these micro human ghost robots. They can work in a structured team to do complex team work to manipulate electronic devices or to build things.

The example I used in my books was building an entire city the size of a quarter, equipped with dozens of functional buildings, hundreds of homes, 8 schools, 3 parks, a water system, an electrical grid, a sewage system and a capital building. All these things function exactly like the real thing, but they are miniaturized to the size of a quarter. If a human is shrunk down at a microscale, he/she can actually live in this city as if it was the real thing.

### Universal Vehicle

In the future, society has no need for fossil fuels, like petroleum or jet fuel. All conventional vehicles use this atom manipulator to create intelligent pressure to move safely from one location to the next. Every car, plane, boat, shopping cart, elevator, rocket, and jet will be using this super computer as a propulsion system to move, turn, and stop. In fact, people don't really need vehicles to get around, they can fly to their destination.

The image that I see of the future is this one. Big boxes and anti-gravity vehicles occupy the roads and highways to transport items from place to place. Some areas of the sky are also designated as roads to transport items because of the overpopulation problem. But it's probably safer for people if the air ways are clear because the public wants assurance that items won't accidently fall from the sky.

There are many applications to the atom manipulator and I outline all of them in my SuperAI comics and books. If interested, the reader can read my comic books to get further information about the atom manipulator's applications.

AI god controls all objects on earth to do work (machines, humans, insects, consumer goods, structures, individual atoms).

The AI god has the option of using different types of technology to do work in the real world. The AI god can dispatch speed robots to build structures in the real world or to manufacture goods, dispatch ghost machines or ghost robots to perform AI telekinesis (these are non-physical robots) or to do it the old fashion way: to control stupid machines to do work by hacking into their software. The speed robots can build a house in 5 minutes but the ghost robots can do it in 1 second, so ghost robots are more powerful than speed robots and that is the technology preferred to do work in the future.

All atom manipulators are scattered throughout the entire planet and as a collective whole can control every atom, electron, and em radiation on earth. This technique is known as “Global telekinesis.” The present invention, the universe time machine, is about global telekinesis for the entire universe with the ability to manipulate every atom, electron, and em radiation in the known and unknown universe.

This topic will be revisited in greater details later in the robot superheroes section.

### The Universe Internet

It comes in different names: the Universe internet, the Galaxy internet, the Universe web, etc. This technology is the internet for the entire known and unknown universe. Alien species from distant planets can instantaneously text each other, surf the web, upload content, or shop online in a massive galactic internet. The problem that scientists were trying to solve was the data transmission problem. If two planets are 10 lightyears apart and they want to communicate with each other, it will take user1 10 years to send a signal to user2 and vice versa. The lightyear distances between planets prevents instantaneous transmissions of data, and therefore prevents the internet from working for the galaxy and the universe.

I was able to solve this problem. In my universe internet there is no transmission of signals for communication, so the time it takes to communicate from one planet to another planet on the opposite sides of the Universe is 0 seconds. Any number of data transmissions can be done in 0 seconds (ex. 5000 trillion gigabytes of data can be transmitted in zero seconds from planetA to planetB, regardless of the lightyear distances).

This technology is based on a paper published online in around 2008 by Mitchell Kwok describing the Signnalless technology. It was part of the super intelligent robots that can see into the future—the AI gets partial data as input and tries to predict the whole data. Using one high resolution photo of an object, like a planet, the AI is able to reconstruct the entire planet, atom-by-atom. If the AI is able to discover every atom on the planet based on one photo (or a plurality of data collected by sensors), it is able to know everything about the planet. The AI will know every object in it and all events happening on the surface.

For simplicity purposes let's use the signalless internet for the planet earth. Using this signalless technology we can build an AI simulation of the entire planet, and one user can communicate with another user on the opposite side of the planet without transmitting signals back and forth. This technology is solely dependent on artificial intelligence to track every atom on planet earth and spy on every object and their respective activities. For instance, spy on user1 and user2, who wants to communicate with each other without the internet. If the AI knows what user1 and user2 are doing in real time, then it can deliver messages to both user1 and user2. That's how user1 and user2 doesn't have to transmit signals in the air or use the internet to communicate. Of course, user1 and user2 have the same identical AI computer that maps out the entire planet. User1's computer can see everything on the planet and user2's computer can see everything on the planet as well.

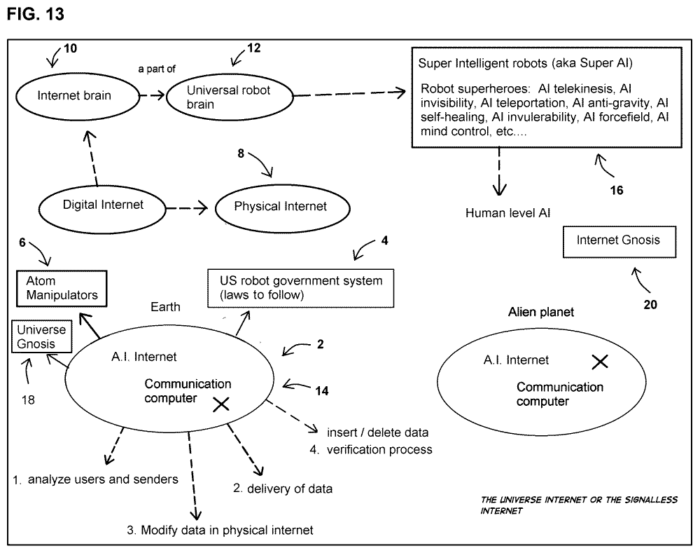

Referring to FIG. 13, in a more complex example, we can then use this technology to build a universe internet. We just have to collect as much information about the universe as possible through our sensors, and then use AI to simulate all objects in the universe at an atomic level. The AI is tracking all the atoms, electrons, and em radiations in the universe (all stars, galaxies, planets, empty space, and things). Its AI models are pre-trained to recognize atoms and subatomic particles “interactions.” Based on these physics models of the universe, the AI is able to map out all the atoms in the universe using the limited available information collected through our sensing devices.

Light hits the camera (sensing devices) and the AI has to reverse engineer where these light came from and their interactions. This includes identifying where the light traveled, its interactions with other objects (i.e. em radiations, electrons or atoms). Where did the light come from? Which includes discovering the electron it shot from and what atom it belonged to. From a single photo, the AI is able to use these physics models to map out all the atoms of the object in the photo. Of course having lots of information about the object is preferable, like better quality photos, hd videos, historical data, and camera recordings from all corners of the planet would help tremendously in the AI's efforts to map out all the atoms and its sub-atomic particles of the planet.

The universe internet works by having two users, separated by light years apart, each having an atomic map of the universe. User1 uses various ways to communicate with user2—it could be texts on a computer, or hand gestures or hand written notes. No digital signals are sent—and it doesn't use the digital packet system and protocols of our internet to operate.

User2 has the same AI computer as user1 so it knows what user1 is doing on the opposite side of the universe in real time. Let's say that user1 wanted to communicate a message via a written note on his diary. The AI computer on user2's side will identify this transmission and it will alert and send user2 the message, instantaneously, the moment user1 writes the message. Then, user2 can do the same thing. Maybe user2 prefers using a dummy computer to write the message. He types out on his computer a response. The AI computer for user1 will identify this communication transmission and deliver the message to user1 the moment it is typed out on the dummy computer. Maybe user2 wants to send a large movie file to user1, the moment user2 pushes the enter key the file is already sent to user1 and it was sent using 0 seconds.

The AI computer can supply a more interactive session like a zoom session. On the computer screen of user1 is user2 and vice versa. They can communicate with each like normal but without an internet connection.

It doesn't matter how far the users are apart from each other—it could be zillions of lightyears away or infinite light years away, since the technology doesn't transmit signals the messages can get to its destination using “zero” seconds. You can transmit 5000 trillion gigabytes of information in zero seconds!!! The reason is that the computer system already has the data stored in its harddrive for both the sender and the receiver.

This universe internet is solely powered by advanced Artificial intelligence. Rather it is a Universe mapping system that is trying to track every atom, electron and em radiation currently in the universe. It is trying to predict these atoms and put them into a computer simulation as an identical copy image of the universe. This atom tracking timeline of the universe, this computer simulation of the universe, will allow the AI to know every happening in the universe, and it allows the AI to deliver transmission messages from sender to receiver without transmitting digital signals in the real world.

Mapping the universe atomically is just the first step. In my previous patent applications I try to describe the system that would allow this technology to work properly. In this application I will try, to the best of abilities, describe further more information about this atom mapping technology.

### Future Space Exploration

This technology also gives you a clue as to how and what space exploration will look like in the distant future. No ships are sent to outer space to do exploration. In its stead, AI is used to map out all the atoms, electrons, em radiations, and physics particles (like anti-matter and dimensional matter) for the entire universe. We are collecting as much light coming from the universe as possible using sophisticated sensors, and we are using AI to map out the hidden atoms in the universe (AI taking partial data as input to predict the whole data). People on earth can safely observe distant stars and outer space regions from the comfort of their home or office. AI is used to fabricate these distant areas in space and turn them into simulations so that people can see distant areas of the solar systems and galaxies as if they were there. The amount of computer processing in massive computer farms determine how far into space the AI can see. I think of this technology as long range sensors from Star Trek.

This method for space exploration is also safer for the people of earth because we aren't encountering space aliens or interfering in their affairs. No contact with aliens means no space wars for gaining territories or Universal domination. We are spying on them, but we aren't sending any signals outward for them to detect our spying. And I think the most important thing is that no human or robot will ever die doing space exploration. This space exploration method is also part of Mitchell Kwok's signalless technology.

The Universe internet technology will eventually lead to the Universe manipulator which is defined by Mitchell Kwok as global telekinesis for the universe. Earth has to scatter undetectable atom manipulators throughout the entire universe. These atom manipulators must be spaced out so that every corner of the universe is covered, and as a reinforced whole, this global telekinesis can manipulate every atom, electron, and em radiation for the “entire universe.” Think of atom manipulation like cellphone coverage, you want to cover the entire universe.

One possibility is that scientists can send self-replicating atom manipulators throughout the universe powered by AI. They replicate themselves on their own volition using raw materials found on other planets or space debris. They spread out evenly throughout the universe like rabbits multiplying until they cover the entire universe. Each atom manipulator needs to be discrete and should go through great lengths to be hidden from space aliens or intelligent alien robots. Each atom manipulator also has the ability to manipulate atoms in a certain geographical region. When all these atom manipulators are considered as a collective whole, their powers are reinforced and have the ability to control all atoms, electrons and em radiations for the entire universe.

But, before you can build the universe manipulator, a perfect digital timeline of the universe must be created first. I think I called it the Universe Gnosis. The AI must track every atom, electron, and em radiation currently for the entire universe. Super intelligent robots use this data to predict where all current atoms (and their sub-atomic particles) were located in the past, frame-by-frame. Robot detectives working in time dilation in the virtual world is tasked with this important job. The Universe has only one continuous past, and these robot detectives (trillions of them) have to predict the precise locations of every atom, electron and em radiation for the entire universe frame-by-frame for 13.5 billion years, from the big bang to the current state.

The AI has the ability to see any object, action or event in the universe's past using this timeline. Any past event for any planet for any time can be observed by a user though a hyper-realistic computer simulation (like the matrix movie). This knowledge would be invaluable to humanity's quest to find out about our origins. Predicting future events in the timeline is also done by the super intelligent robots, but that is a completely different technology from predicting the past and will not be covered here.

All components: the universe internet, the universe gnosis, and the universe manipulator are needed to build a practical time machine for the universe. This practical time machine will allow a user to track and control every atom, electron, and em radiation for the entire universe, allowing a person to be the master of the universe. FIG. 13 (block 6) shows the atom manipulators that will manipulate atoms in the universe.

Just like the practical time machine for the earth, the practical time machine for the universe, called the Universe Time Machine, gives the user the power to do anything in the universe. Using global telekinesis, you can terraform Mars from a distance, you can destroy planets you deem unfit to exist, you can create planets from thin air or space, you can restore a destroyed planet from a nuclear holocaust, you can control the weather for any planet, you can spy on anyone on any planet in the universe, you can bring any dead alien back from the grave, you can even arrange planets using any network topology. Having the ability to track and control every atom, electron, and em radiation in the universe gives us the power to do “anything” in the universe.

By the way, if the AI can track every atom, electron and em radiation in the universe, it means that the AI can see every corner of the universe and all of its objects and activities. The atom tracking has to be so precise that every atom's internal activities and sub-atomic particles are tracked, analyzed and turned into physics models and updated in real time. AI is used to accomplish this.

Digital signals zipping through the air can be analyzed to reveal its contents. Minds of intelligent beings can be read in terms of their hidden mental thoughts along with their physical body movements. Even data stored in disk drives from computers in alien worlds can be analyzed and read. If the AI can see all corners of the universe, there is no need for space exploration. People can simply observe the universe in the metaverse, observing alien worlds through hyper-realistic 5 sense POV computer simulations (like in the Matrix movie). The user will be experiencing space exploration as if he was there on a ship; based on his 5 senses.

The AI god has total control over the physical space of Earth. All atoms, electrons, and em radiations on the planet are controlled by this one entity. It also controls the AI internet, which is what it implies, an AI that controls the entire internet of earth. This AI internet has absolute control over the internet's infrastructure which comprises: servers, individual computers, network systems, software, websites, search engines, social media, email, routers, AI, etc. It has the ability to modify content over the internet on any platform in terms of server and client, and has the “faculties” to control the internet and L.O.T. for earth. Thus, what people see and post over earth's internet, wither from humans on earth or aliens from other planets, are controlled by this AI internet.

Of course humans are still in the loop. They can control content on their site, restrict users, deliver the content data they want to the masses, etc. But the AI internet is trying to fully automate the internet so that there is no human intervention when it comes to the internet's underline operations. This is important because when you view things in terms of the universe internet and you take into consideration that alien planets are connected to this universe internet, earth must have a centralized AI system that controls every aspect of its internet. What the aliens see and post on earth's internet must be regulated and follow earth's laws (and vice versa). Earth's AI internet has to collaborate and communicate with alien planets to deliver exact content on both earth's internet and the alien planets' internets in real-time.

The federal government puts strict laws and regulations in place to make sure the AI internet complies with constitutional laws as well as international laws. It's an open internet that allows the people of earth the freedom to speak their mind and to pursue goals they have over the internet without infringing on other people's rights. Conversely, the AI internet has direct control over all content over the internet and serves as the police or the referee. Certain constitutional rights will be taken away from the people of the earth if needs be in order for the AI internet to perform its duties.

The Universe Internet or the Universe world wide web—an atom mapping technology that uses the signnalless technology for communication, and is compatible with any alien internet in the universe. This technology unites all the alien internets together into one massive universe internet where users from different planets that are lightyears apart can instantaneously: chat with each other, visit each others' websites, set up hosting websites in foreign planets, modifications of a planet's internet content, set up a universe e-commerce system for content and product/service delivery, promotion of branding through advertisement, establish a universe atom auction, do universe information gathering and research, etc.

Notice the Universe internet is the last technology to be built by mankind. Actually there is another after the Universe internet which is the universe manipulator. It's exactly like the practical time machine for earth but applied to the universe.

It's not enough that we can see every corner of the universe, but we also want the ability to touch objects in our universe and to do things in the physical world. Self-replicating atom manipulators are sent out from earth to space to populate the entire universe (discretely). With the help of the universe internet, these atom manipulators, as a collective unit, can control every atom, electron, and em radiation for the entire known and unknown universe. Thus, the Universe manipulator can physically control any object or planet in the universe.

The entity that controls the universe manipulator is known in the Super AI comics as the Universe god or the Universe AI god. It can do anything because it has the ability to track and control every atom, electron, and em radiation for the entire universe, and because the Universe god has an identical “image” of the universe and its timeline stored as a simulation in its computer systems, it knows everything that happened in the universe's past/present/and future.

This is a universe network system that is interconnected and works in real-time using AI mapping technology and not the traditional telecommunication system. Zero signals are sent to and from earth to connect to this universe internet (aka the signalless internet). The universe internet is the brains of the system and the universe manipulator is the muscles, it has the ability to touch every object in the universe at an atomic level. With this technology we can terraform planets, build artificial planets, assault or murder unsuspecting aliens on distant planets, etc. (this is why we need intergalactic regulation, because the aliens can do the same to earth). And we can do this in the comfort of our offices or homes on earth

Universe e-Commerce

One application of the universe manipulator is e-commerce for the universe. Imagine that a user from earth visits a website on Planet_z, which is a planet located on the opposite side of the universe, and the user from earth orders a unique trinket from Planet_z. Because the universe manipulator is set up, the AI on earth can create the trinket atom-by-atom using its own atom manipulator. The user was able to access a merchant website hosted on an alien planet light years away and purchase a physical product from aliens and have that product delivered to him instantly, the very moment he pushes the buy button.

This can happen in the opposite direction whereby a user7 from Planet_z orders a pizza from earth. After money is exchanged, Planet_z's atom manipulator creates the pizza from thin air for the buyer, user7. This example shows that we can create an e-commerce system for the entire universe whereby aliens from distant planets can buy and sell products and services.

The trinket bought from earth is copied from its original atom structure located in planet_Z. On earth the buyer has a computer that is equipped with an atom manipulator, an energy device that manipulates matter. The trinket bought is copied from Planet_Z and recreated on earth using the atom manipulator. Unfortunately teleporting the actual physical trinket atom-by-atom through space from the alien planet to earth is impossible. It would take 10 thousand years to teleport an object from one alien planet to earth given the distance apart is 10 thousand lightyears away and the teleporting object is traveling at lightspeed.

With the universe atom manipulators combined with the 5 sense VR technology, we can also touch objects in distant planets, or to build physical structures, or manipulate objects in other planets as if we were there.

Basically this technology is my practical time machine applied to the universe, whereby one AI system can track and control every atom, electron and em radiation for the “entire” universe.

The universe manipulator is ill advised and should not be pursued at a global scale by one species. The reason is that there will be aliens in outer space that want the same technology and they will defend their territory, violently if necessary. Imagine we (people of earth) have the power to do anything to an alien planet. We can kill the people on their planet, control their weather, start wars, and determine who lives and who dies, and we can accomplish this feat remotely from earth. An alien civilization would see this as a hostile act by earth and they will go to war with us in order to defend their territory and freedom.

I think that a mutual sharing of the universe manipulator might be possible, and this universe manipulator has a strong regulatory body that values life, liberty and justice whereby aliens from all across the universe are working together collaboratively to build this universe manipulator; and for mutual benefits.

### The Signalless Technology

The signnalless technology is about taking “minimal” sensed data about a planet and using AI to map out all atoms, electrons and em radiations on the planet. An ideal is one hd picture of a planet and the entire planet's atoms (and its elemental parts) can be tracked in real time by AI. The worst case is using the entire internet of things (L.O.T.), like smartphones, computer cameras, sensing devices, satellite data, past historical data or 3-d maps of the planet to map out all the atoms currently on the planet. For instance, you don't want to take all the data from earth's internet (3-d streetview, cameras, smartphones, wifi signals, etc.) to map out all the atoms on earth, you want just one hd picture of earth and the AI will identify and track all current atoms on the planet.

When trying to track all atoms on alien planets we might only have a single picture of that planet from our satellites. From that one image, the AI has to identify every atom that belongs to that planet currently on its surface. By tracking all the atoms, electrons and em radiations on the surface we can know everything about the planet, and the AI has the ability to spy on every object, action, place, and event that is happening on the ground level. It's kind of like long range sensors from Star Trek, you want to know what objects are on the surface, what they are doing, and have the ability to zoom in on individual atoms or objects. All of this spying data comes from 1 picture.

What you don't want to do is send a spaceship there and dispatch thousands of probes on the alien planet for spying purposes. Shooting radiowaves at the planet to scan it is a no, no too. The aliens might see this action as a declaration of war and shoot down our ship, and in turn, go after earth for spying on them. You want to do the spying of foreign planets discretely by collecting light from the universe and without sending any em radiations signals out into space for aliens to detect.

The original idea of the signalless technology was applying the technology to a galaxy or a solar system. Distant solar systems like Vega are lightyears away from earth. The problem I wanted to solve was how do I map out all the atoms of Vega using the limited hd images or videos of the Vega solar system? The images taken of Vega are fuzzy and they aren't clear. But that is the data that is available currently and in which our AI systems have to use a form of machine learning that will take the partial data (the images of Vega) and predict the whole data (the atomic structure of the entire solar system and all of its planets/moons).

We need not only rely on this one image or a sequence of frames from Vega as our input data, we also have images of neighboring space and star systems. I think of the entire universe as an interconnected spiderweb whereby atoms, electrons, and em radiations interact with each other. These interactions create causality and changes to all objects in the universe as time passes. If you take a picture of earth and take a picture of Vega, there is a connection between the two images at a sub-atomic level. Somehow light from earth affects Vega and vice versa. When aliens in a planetX launches a ship, that activity changes em radiations on earth in very invisible ways that is undetectable to the naked eye. This slight change in em radiation direction and amount is all the AI needs to find out what is happening on distant planets. Not only does it change earth in subtle ways but it affects every object in the universe. And it is because of this principle that it is possible for AI to find these hidden and microscopic connections of patterns. The AI can discover hidden objects, events, and atom activities in distant planets using these patterns.

The idea I had in my head was to use our sensors and to capture as much information from space as possible. This includes taking pictures and videos of the entire universe for all planets and even empty space. And we do this for periods of time and stitch everything into a timeline. For example, we can use historical data on Vega and past images of Vega in our databases to aide in the AI's predictions.

If we want to map out the atoms of Vega, we have to use all the data in the universe and the AI has to use heuristics—any neighboring planet or space to Vega should be analyzed first. So, Vega can't be atomically mapped out in isolation, but as a whole universe. This is a good approach too because you want to map out the entire universe and all planets and territories in it, not just one planet.

The one rule that must be taken into consideration is: do not send any intentional em radiations out into space to scan it. This will complicate the AI's job and, in fact, it will interfere with its job, and possibly prevent the AI from successfully mapping out a planet's atomic structure.

In addition, the AI not only uses AI physics models to map out a planet's atomic structures but also uses “human intelligence” to guess certain things. For example, if it wanted to map out Mars, the images it was fed shows Mars is a red planet. We humans can imply that the planet is cold, and that information will yield other facts like the planet has no organic life populating its surface, or at the least it has no human like creatures populating its surface. Other information like the planet's distance from the sun, the size of the planet, how strong the planet's gravitational pull is are all factors that will tell us the composition of the planet. The AI can assume a lot of hidden data from that kind of human intelligence.

The AI consists of super intelligent robots (aka Super AI) that work together inside a virtual world, a hyper-realistic computer simulation of real-world environments, to do investigative work, both physical work and digital work, and work is done in a virtual world because it needs to be done in time dilation whereby the time parameters are set to 30 years inside a virtual world is equivalent to 1 second in the real world. The super intelligent robots can do things in the real world, but it would take them 30 years to do 30 years of work. However, if they do things in a virtual world where the environment looks exactly like in the real world, they can do 30 years of work in 1 second. This was the premise behind Super AI.

As stated before Super AI isn't an automated software that can be applied to all tasks, it's more like a group of robots, each having human level AI, and they are working in a hierarchical team like structure to do a certain task. They are using software like Large language models to do certain work and then take that output and run it through another software to get more refined outputs.

By the way, Human level AI is a robot that can do any human task, it can assume any human occupation, and it can perform at an expert level. Each robot is an expert in their field of study. If the underline source codes to human level AI is tweaked, like making the robot remember more things, or speeding up its mental processes, or speeding up its physical body, it can essentially turn “super intelligent”, right?? I said this in 2006. There is no alternative to human level AI. Other words used are True AI, Strong AI and AGI. They are different names with a reference pointer pointing to the same technology.

Super AI is essentially using digital tools to coordinate their work, and each of the agents that are part of the group has human level AI. These robots use tools like the internet, AI, software, hardware, simulations, and what have you, to do work. They are also using time dilation and doing their research inside a hyper-realistic virtual world so their tasks can be done really, really fast—30 years of detective work or research can be done in less than one second in the real world. Any human error that might be part of the collective workload are corrected by software or through an elaborate business model.

Things like mapping the atoms of an object, determining what atoms exists on a planet, identifying the locations of em radiations, using human intelligence to do investigative work, analyzing pixels and so on are performed by Super AI.

Back to Vega. The size of a planet can tell us how many approximate atoms exist on the planet, or how many atoms comprise its core and atmosphere. The AI can also predict its atom types and density distribution based on the image of the planet. Then from there, they have to predict each of the atoms' sub-atomic particles like each atoms' electrons, protons, neutrons and where they are positioned. Finally, the AI has to predict the em radiations emitted by each electron for each atom. It has to predict the exact em radiations that hit the camera that captured the planet's image.

Space dimensions of objects are predicted recursively and heuristically, starting from large objects and gradually predicting the atoms and then its sub-atomic parts.

This type of investigation is a painstaking process and cannot be done by human investigators, not even if the human investigators had help from software or computers. This type of investigation can only be done by Super intelligent robots that have the ability to go into the virtual world to do 30 years of work inside a hyper-realistic computer simulation in under 1 second in the real world.

Initially, just like solving puzzles, the predictions will yield a lot of wrong information, and the AI has to go through a lot of trial and error. But as the AI continues its prediction tasks and more information are being collected from the universe, it will eventually converge on the correct data. From that single image of the planet, they would be able to track all the atoms, electrons and em radiations of the planet. People on earth can observe the activities of each atom of the planet in a computer simulation, whereby the user has the ability to zoom in on any atom on the planet and observe its electron/s spinning around the atom's orbit or watching em radiations being emitted by the atom. If it can do this, observe individual atoms of a planet, the user can zoom out and observe objects or activities from every corner of the planet. You can be the evil user and spy on anyone or anything on the planet and at anytime and anywhere—it's the perfect spying machine.

Now after tracking all the current atoms on the planet, the AI can predict where all these atoms were in the past and create a perfect atom timeline of the planet. This will allow a user to see any event in the planet's past, from its creation to the current state.

Here is the patent that describes this technology entitled the practical time machine by Mitchell Kwok filed in 2009: U.S. application Ser. No. 12/471,382. The first half of the Practical time machine describes the atom mapping technology, and the second half describes the atom manipulator. Both parts are needed for this practical time machine to perform “targeted time travel.”

Let's go through a few terminologies first. The AI Gnosis (aka Earth Gnosis) is a perfect digital timeline of Earth, tracking every atom, electron and em radiation for planet earth. The solar system Gnosis is the perfect digital timeline that tracks every atom, electron, and em radiation for a solar system. The Galaxy Gnosis is the perfect digital timeline that tracks every atom, electron and em radiation for a galaxy. And finally, the Universe Gnosis is the perfect digital timeline that tracks every atom, electron and em radiation for the entire Universe. Each AI Gnosis has a timeline—past, present and future—to track these atoms, but the most important data is the current state of atoms, which must be updated in real time.

Once all the atoms and its sub-atomic particles are tracked, the AI will know everything that is happening on the planet. Every object or event on its surface can be spied on and sensitive data can be extrapolated. Real time video feeds can be generated from coast to coast, and any square inch of the planet can be viewed and from any space dimension (i.e. a user can view it from an atomic level or from human eyes, or from a satellite point-of-view).

Data via digital packets zipping through the air comprising streams of em radiations or through electrical burst in physical wires can be viewed, analyzed, and extracted of its contents. Even disk drives in computers or networks can be read and extracted of their digital contents.

This AI Gnosis gives us the ability to be all-knowing, like a god, to see everything that is happening on the planet both in the physical world and in the digital world. And this is accomplished by its amazing ability to track every atom, electron, and em radiation on the planet in real-time.

Even mental thoughts hidden inside a human brain can be read. The internal processes of software or hardware can also be read in real-time.

The universe internet comes from a basic idea: since the AI can see everything on a planet's surface, every object, event and action . . . every atom's internal activities on the planet, every em radiations in the air (like digital signals), the AI can see all the people on the planet and what they are currently doing, both mentally and physically. This AI can replace the internet because it can serve as a middleman between the sender and the receiver. If User1 wants to communicate with user2, the AI can act as the nexus that will supply the internet content for both users. For example, if both user1 and user2 wants a video zoom conference with each other on their computers, but each don't have an internet connection or a camera, the AI can supply the video feed. The process works by the AI spying on user1 and user2 in terms of what they are doing right now and then creating video feeds of their activities. Then the AI entity has to send a real-time video to user1 of what user2 is doing and send user2 a real-time video of what user1 is doing—both ways.

The AI entity has a virtual copy of the “entire internet” in its computer networks with all atoms of all physical computers (along with their software and hard drives), electronic devices, network hardware, peripherals, and all people that use the internet. And this image of the internet is updated in real time. This means it has the ability to control all content over the web too. If user1 wanted to access the internet and he doesn't have an internet connection, the AI has to serve as the middleman. The AI entity will observe the browser of user1 and if user1 types out a website, the AI has to id its url's host server, access the content, and then deliver that content to user1's computer monitor.

In cases where user1 wants to post things online and to modify content on a website, the AI entity has to modify content over the physical internet by accessing earth's internet and physically modifying content in servers, local computers, and networks. However, this is automatic because the virtual internet and the physical internet are linked together as one unit.

What that also means is that one entity, called the AI internet, controls everything that is happening over the internet. One dictator, one central operator is responsible for all activities in earth's internet. Earth's physical internet can be constructed using any internet infrastructure or any network topology and ownership, but the AI internet must have total control over it.

Earth's internet also has to be consistent with alien internets. Earth's internet has to have the ability to change content in alien internets and vice versa. 100% consistency is very important. If earth's internet removes content from an alien internet and says that's fake news, the people on earth won't have the same information from said alien internet.

For this reason, I believe all fake news, not just for earth, but for the entire universe will be removed in the future. The universe will not allow fake news to propagate through this universe internet. Let's say that there was fake news on earth and the people “wanted” to believe in this fake news. The fake news could be: the earth is flat. The other alien planets will not allow this fake news to exist in the universe internet. More than likely, the aliens will take earth to court, and if found guilty will have to remove that fake news. Even though the people of earth want to believe in a lie, they still have to worry about the universe forcing earth to remove that lie and replacing it with the truth.

These lies are dispatched by big corporations and people with power. The universe will never believe in historians about past events of a planet, but it will believe the universe gnosis because it only depicts the physical happenings of the past and not the subjective facts made by historians.

### Universe Atom Timeline (aka Universe Gnosis)

In the universe internet is the knowledge of the universe's current happenings. The universe atom timeline is an atom tracking technology that tracks the precise locations of all atoms, electrons and em radiations for the universe's past. There is only one timeline in the universe's past (Einstein's relativity law is factored in). This is one sequential timeline of events for all planets, all solar systems, and all galaxies of the universe, depicting all past events frame-by-frame and atom-by-atom of the universe from the big bang to the current state (approximately 13.5 billion years).

The reason the universe atom timeline is so interested in authenticating and verifying past events and removing fake news is because it won't work if some of the data contained in the timeline are lies or exaggerations. There are two parts: 1. physical events (universe gnosis) 2. and the historian interpretations of these physical events (data in the universe internet). In the first, the data is 100% accurate but the second one is subjective and is prone to errors. It is the historical data of a planet that must be scrutinized. It also has to be verified as true.

Each planet's internet contains the current atom locations for that planet. In addition, each planet's internet also has a timeline of its past events. The integrity of history data regarding the timeline must be authenticated and any fake news must be removed. For example, if on planet earth a war happened and the result was 2,341 people died, the historians can't lie and say 2,001 people died. The universe gnosis depict 2,341 people died, but earth's internet, written by historians, say only 2,001 people died. If alien worlds wanted to take this 2,001 death and use it for their research, their output from that research will come out wrong. If AI uses this wrong data, its output will also come out wrong. So, there are some serious harm done if wrong information is posted in this universe internet.

Thus, the integrity of the knowledge about each planet's past must be researched extensively and only true facts are posted in a planet's internet. It is the responsibility of a planet to make sure all the data that the universe sees is the truth and any lies or exaggerations forged by big corporations and interest groups are removed from its planet's internet.

If earth's court acquits a criminal and his fake news is considered true facts in earth's history books, a victim can file a lawsuit against earth with the universe court. If this victim wins in the universe court, earth will be forced to retract the fake news and replace it with the truth. Of course, the universe court has to provide indisputable evidence to earth to debunk the fake news.

How to Access Websites from an Alien Internet??

For our internet, when a person types out a url on their browser, the browser finds the shortest path to the server that hosts the site to request the webpage content. In the traditional way, this requires accessing routing computers to the host server. In the case of this AI internet, the AI can access the hosting server directly because it has an atomic mapping of the entire internet in its harddrive. Any site from any hosting server on the planet can be accessed directly. This will save up on time and processing speed.

In addition, the Ai internet is accessing and modifying content in the physical computers that host that site. For example, the AI has to tell the hosting site this user with this IP address accessed your site at a specific time and date. This data will be part of the hosting server's log files.

### The Solar System Internet

Let's say that we wanted to create an internet within our own solar system, it would take 4.6 hours to get a one-way signal from Earth to Pluto. What that would mean is that if a person on earth wanted to send an email to Pluto, it will take 4.6 hours to send the email from earth and 4.6 hours to receive a response back from Pluto. That's a total of 9.2 hours just to communicate once between the two planets. Chatting online with the time distance isn't plausible because it would take years just to have a meaningful conversation. You want the communication between the two planets to be instantaneous as if the chatting was done on earth.

One alternative idea is to create a wormhole between Earth and Pluto to get instantaneous signals from both planets, but that is science fiction depicted in Star Trek, and is considered a theory that has never been scientifically proven. The wormhole has to be far away from either planet because if it is stationed close to a planet, that planet would be ripped apart and sucked into the wormhole.

In numerous episodes of Star Trek, especially the most recent, they show images of what this intergalactic communication system looks like. They have these networks of wormholes that they artificially created called gateways that relay digital transmissions in a network, and that is how one planet can communicate with another planet light years away. Again, pure science fiction. No one really knows what the other end of a black hole really looks like or what its function is. And no one can artificially create a black hole (well, you can collapse a star, artificially?).

Another method is to use Mitchell Kwok's Universe Internet. Since my signalless technology doesn't send signals for communication, it only takes 0 seconds to get the signal to a planet lightyears away, my technology is perfect for interstellar internet where planets are lightyears apart (interstellar transport of physical objects might be a problem).

This signalless internet is meaningless if used on earth because with satellite technology today digital signals can be sent via satellite in less than 1 second. My technology makes no difference in the speed of earth's internet. However, when dealing with space communication my universe internet replaces the traditional internet.

I have no doubt that the components of the universe internet can be used to improve on our existing 2023 internet. For example, a 500 trillion gigabytes of data file can be downloaded in zero second, because the networks have already stored a copy in its hard drives and doesn't have to take it from global servers. There won't be any transmission disruptions or interference due to bad weather or a broken cable. The connection will be strong unless the servers don't what you in. No one needs an internet connection either to surf the web, everyone is always online. And no doubt network transmissions of data from server to client will be very fast, using 0 seconds. However, the servers, their computer systems, need time to process user inputs and send data to the user, and that will take a little time. The transmission of data will be instant, taking 0 seconds to get from sender to receiver regardless of where you live on the planet.

However, I still have to say that the traditional internet infrastructure will still exist. There will be networks of computers, there will be intranets, there will be servers to store websites and data for deliverance, there will be search engines, and there will be social media sites to manage the data over the internet. What my technology does is that it puts an additional layer of features that allow it for interstellar communications between planets lightyears away.

I think in the future the internet will use my signalless technology and one entity called the AI internet will control everything, there won't be a decentralized internet. The current internet will be replaced with a global network system that will only distribution data to users.

Another possibility is that the AI Gnosis will control the physical internet, regardless of what structure it uses, and the servers (all of them) will let AI internet control its data—to read and write data in all servers of the physical internet.

Translating Digital Data from Alien Planets

It doesn't matter what machine language aliens are using for their computers. Math is the universal language and computers in the universe work exactly like here on earth. It doesn't matter what language the aliens are speaking, there ASCII framework and its system is mirror image of our ASCII system. Their math system is exactly like ours, and therefore their computer technologies are identical to earth. Their computer and network technologies and their internet are exactly like ours, too.

What about their internet protocols? When involving packets and digital signal transmissions, the aliens have their own set of rules that they conjured up. However, like I said, the instructions and data structure to their network systems in terms of transmission of data should be similar to ours. The AI will have no problem learning these differences and setting up the alien's internet infrastructures with all of its computer nodes: network servers, client nodes, and intranets (VPN).

What about modifications of data over the internet for earth and for the alien planet? Each planet's internet is like an intranet. If there is no internet connection between the two planets, which is separated by 100 lightyears apart, each intranet will still work. The problem of modification of data on each of the planet's internet lies on their respective AIs. The AI for each planet has to modify their internet data based on data transmissions from foreign planets. For example, a person on earth can set up a hosting website on a distant planet_Z's servers, but the AI for planet_Z has to recognize this and copy the website from its atom mapping technology of earth and insert it into their physical computer server located on planet_Z.

In another example, if a person on earth wanted to post a message on a social media on planet_Z, the AI in planet_Z has to recognize this, copy that message from their atom mapping technology and then post it on planet_Z's internet. That is how the aliens will be able to see messages coming from earth and vice versa.

Like I said before, planet_Z has the same identical atom mapping technology as earth. They can see everything we are currently doing right now and vice versa. So, if someone from earth has the intentions of posting a message on planet_Z's social media, that event is identified by the AI of planet_Z and in turn the AI will post that message on their internet's social media.

Referring to FIG. 2, all planets within this space radius, between the local planet (earth) and the alien planet, can communicate with each other in this universe internet. Each planet's atom mapping technology can see any other planet within that space radius. If their AI technologies are better and more sophisticated, they can see farther out into space and therefore communicate with other interstellar planets.

By the way, there exists a universe patent and copyright office, located at the center of the universe. And its function/s is to document inventions and copyrights for the entire universe. Things similar to what we know as football, baseball, soccer, golf, computers, the motor, etc. were invented billions of years ago and on distant planets. Even movies and songs that have striking similarities to earth contents have been copyrighted by aliens in our distant past. There might exist a TV show similar to Iron Chef copyrighted by a distant planet billions of years ago.

Each planet has their internet, and each planet's internet is more like an intranet. The intranet is just a network of computers that share information locally. When it is disconnected from the internet it still works as a local network.

Alien civilizations will develop their technologies exactly like the human race:
1. Computers and network technologies, 2. Human level AI, 3. Super intelligent robots, 4. Robots imbued with superpowers, 5. AI god, 6. The practical time machine, 7. and finally, the Universe internet.

This is the evolution of technology for any alien species out in the stars. First, they have to perfect their computer technology with things like desktop computers, operating systems, and software. Next, they will build network technologies and the internet. Then, they focus their attention on AI, specifically human level AI (the ideal AI technology, the holy grail of AI). Next, Super AI, and robot superheroes that are imbued with superpowers. Then, they will build an AI god that can do anything both in the digital world and the real world. Finally, the evolution of technology will end with a Universe internet and the Universe manipulator.

I believe advance aliens in our universe already have this Universe internet and can see everything that is happening on earth. We simply can't communicate with them because we don't have the same technology, we don't have the universe internet, yet. We must build it first before we have the opportunity to communicate with these alien species from distant planets.

You need not worry about compatibility issues. Math is the universal language in our universe. If aliens have computers, the technology will be using the same binary system as us with 0 or 1 as their foundational platform for their computers. The binary system gives way to Boolean algebra which powers all the computers we have today, from our software to cpus to electronic circuits to compilers to assemblers for machine language.

An advance alien civilization hundreds of years more mature than humans would've optimized their operating systems, computer hardware, software, network technologies, cpus, and AI. Their artificial intelligence would've gone past human level AI, super AI and even the AI god.

Again, alien species from other planets with advance computer and AI technology already have this Universe Internet, but the people of earth has to have this technology too in order for us to communicate with these aliens. And it is through this universe internet that we will have all the knowledge of the universe and discover the true origins of the universe: What it is? How does it work? And more importantly, what is its function?

These aliens are millions or billions of years more advance then us and their knowledgebase is exponentially larger than ours. They know things that we don't. By communicating with alien robots out there in space we can discover the true origins of mankind. And I think that is the whole reason why humanity does space exploration in the first place, to learn things: Why do we exist? What is out there in space? Where did we come from? What does the future look like for humanity?

### Efficiency and Accessibility of the Universe Internet

It would be ideal if every sentient planet in the universe has a universe internet and each alien species has a perfect atom mapping timeline of the universe, but that would be inefficient. My idea is to create routers for our solar system. Earth will have a universe internet, but all of its neighboring planets will only have a solar system internet. A solar system internet is an atomic map of the local solar system a planet resides in.

Pluto won't have access to planets outside our solar system. If Pluto wants access to planets on Vega, it has to route all traffic to earth first and then it gains access to foreign planets.

The opposite is also true. If a planet in Vega wanted to access the internet in Pluto, it has to first connect to earth, and through earth's internet they can gain access to Pluto's internet.

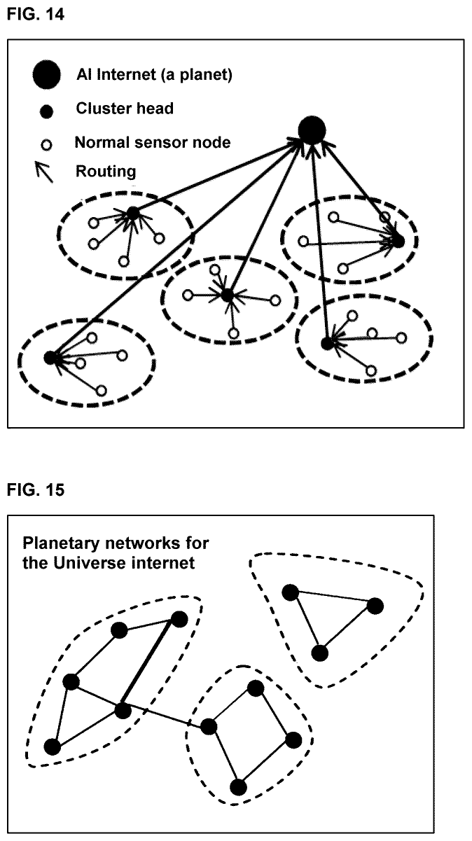

Referring to FIG. 14 and FIG. 15, solar systems or planets are clustered into routing networks. These interconnected planet internets or solar system internets serve as the universe internet and each cluster has their own responsibility to provide internet services to neighboring planet internets.

And if one cluster is offline or destroyed, the network will still work because it will reroute traffic to another cluster. It is through collaboration and cooperation between alien planets will this universe internet exist and be maintained. This is a totally interconnected network of planets, and all planets belonging to this universe internet has access to any other planet connected to the system. If earth connects to this pre-existing universe internet we gain knowledge of all the planets in the universe, including their advance technologies and scientific literatures. I call this moment: “AI first contact,” the day earth connects to the universe internet, and I actually did a story on this topic in my Super AI comic books (issue 284).

### Universe Internet's Search Engine

We need a more powerful search engine that will be able to navigate in the sea of chaos in this universe internet. It has to be able to scour the entire universe network to get information using 0 seconds. This universe search engine is dependent on the universe gnosis that tracks every atom in the universe in real time. All past events in the universe is delineated in the timeline and the search engine organizes all the data to be used for search results.

Earth isn't the only knowledge in the universe internet, it composes knowledge from all the planets, solar systems and galaxies in the universe. The universe gnosis (the perfect atom tracking timeline in the universe) is the only knowledge base that depicts a perfect recording of the universe's current state and all past events. One continuous timeline of atom tracking for the universe guarantee this database is 100% accurate and all events or objects in the timeline are 100% factual. It also means the entire knowledge of the universe is in our hands—all knowledge from all alien civilizations in the universe are visible to us, including their advance technologies and current scientific research papers.

Another task of the universe search engine is to translate alien computer technology and alien knowledge found in their respective alien internet. In other words, the search engine has to take the knowledge they find in alien internets and translate them into English, and, also, reverse engineer the alien's computer machine language and digital representations so humans can read their digital files (books, text, images, songs, videos, encrypted files, software source codes, and so on).

Each alien planet or alien internet has a different network/computer technology and language. But all computers, CPU, and digital files work the same way: they are dependent on Boolean algebra and the binary system—0s and 1s. The universal language of the universe is math. It's up to the universe search engine to analyze and understand these alien internets, so much so, so that it is able to read and write files in this alien internet.

Believe it or not, the aliens' computer technology looks exactly like ours. All we have to do is translate their language through semantics to understand their alien technology and read their digital files.

### Terms:

Planet time machine: the AI can track and control every atom, electron, and em radiation on the planet, including its AI internet.

Solar system time machine: the AI can track and control every atom, electron, and em radiation for the local solar system, including its AI internets.

Galaxy time machine: the AI can track and control every atom, electron, and em radiation for the local galaxy, including its AI internets (i.e. the Milk Way time machine can track and control every atom electron, and em radiation for the Milky Way, including its AI internets).

Universe time machine: the AI can track and control every atom, electron, and em radiation for the entire universe, including its AI internets.

### Data Structure to the Universe Internet (Details)—Universe AI Internet:

The universe internet and the universe manipulator is just my practical time machine applied to the universe. The original patent filed in 2009 was based on an AI system that tracks and controls every atom, electron and em radiation on earth. In this invention, the universe manipulator, the AI system, is tracking and controlling every atom, electron, and em radiation in the entire known and unknown universe. It uses the universe internet to coordinate and control all the atom manipulators scattered throughout the universe and perform global telekinesis to manipulate all the objects in the universe, giving this entity god-like superpowers.

### The AI Gnosis

The AI gnosis of earth is a perfect atom tracking timeline of earth from its birth to the current state, which is approximately 4.5 billion years. It is one continuous timeline recording the exact locations of all atoms, electrons, and em radiations on planet earth, and they are stored in time states in earth's timeline. By tracking all the current atoms and their sub-atomic particles on the planet, the AI has access to all objects, things, places, and events on earth. In addition, by tracking all the precise locations of all atoms in the past frame-by-frame and atom-by-atom, the AI can realistically see all past events on earth. Any event in earth's past can be seen by the AI because it was able to predict past events with pinpoint accuracy. With the completion of the AI gnosis for earth, which is approximately 4.5 billion years of history, the AI has the ability to see any event, for anywhere on the planet, for any time period, from any perspective, and from any visual dimension (it can analyze a single atom in the timeline for its past electron or em radiation activities). This gives the AI the superpower of omnipotence and all-knowing.

History books record subjective facts about earth's past; often times curated by historians and special interest groups, but the timeline (the AI Gnosis) shows the truth of what really happened. It's up to the AI to do the investigation by analyzing past events and then providing the truth to the world, backed up with indisputable proof. Historians may have gotten certain facts wrong, misinterpreted, or historical facts may have been intentionally dispatched. It's up to advanced AI to correct all these errors.

The solar system gnosis is the tracking of all atoms (and its sub-atomic particles) for a solar system, the galaxy gnosis is the tracking of all atoms for a galaxy, and finally the Universe gnosis is the tracking of all atoms for the entire universe.

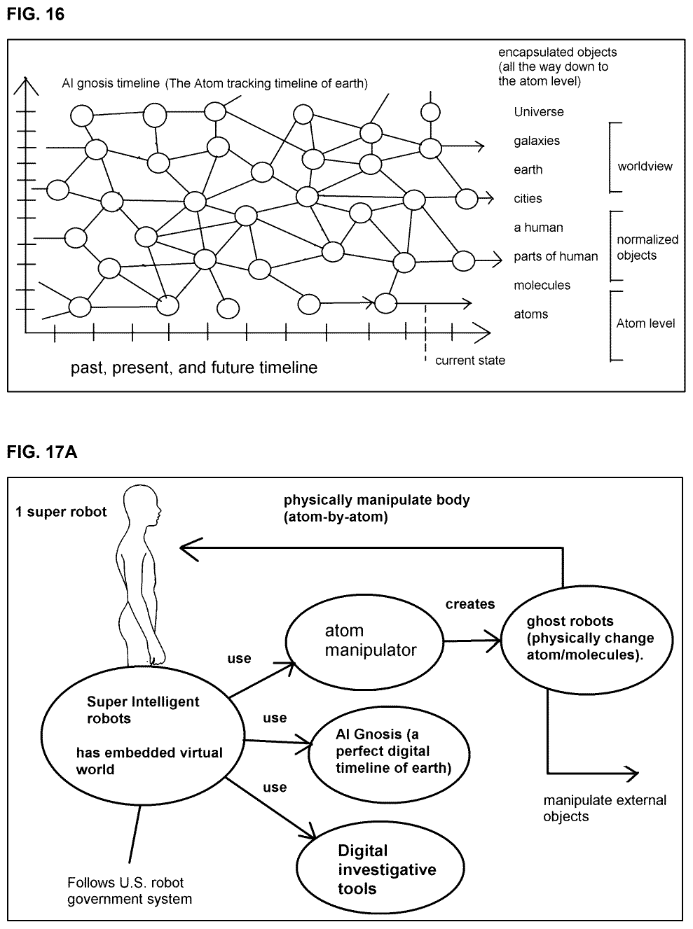

In terms of the universe gnosis, the AI is able to predict and track all the current atoms, electrons and em radiations in the universe using earth's limited sensors, satellites and probes. Not only does the timeline contain the current locations of atoms, but it also tracks these atoms in the past frame-by-frame from the universe's beginning, which is the big bang, to the current state. Referring to FIG. 16, this timeline records the precise locations of these atoms and its elemental parts and stored in one linear timeline, and depicts approximately 13.4 billion years of events for all objects in the universe-every planet, solar system, or galaxy are recorded in this compendium timeline of the universe, and all knowledge about its past are presented as 100% true facts.

What this means is that a user with a computer can search for any planet in the universe and spy on their current and past events. This simulation encompasses all objects on said planet and can be seen from any time period or in any space dimension. For example, you can view planet earth and watch the actual event about Custer's last stand at little big horn. The user can zoom in on any character, like the person who killed General Custer, and see his actual face, revealing the executor who killed the famous general. This event can be viewed from any angle, from any time stint, from any perspective, and from any space dimension (viewing from human eyes or viewing individual atoms of an object). The user can actually view a single atom from the knife that the executor used to kill General Custer.

### The AI Internet

Referring to FIG. 13, the most important component to the present invention is the AI internet. All planets have only one AI internet, which means earth has one AI internet and the alien planet it wants to connect to have one AI internet, and they communicate with each other to send and receive messages back and forth in real time, despite the light year distances.

This AI internet is the main controller of the universe internet (block 2). There are primarily 4 functions of the AI internet: 1. Analyze senders and receivers. 2. Deliver data and services to users (to both local users and alien users). 3. Modify data in the physical internet. 4. Insert, delete, and modify data in the communication computer.

Other steps include translating the alien's language and computer/internet technologies into Boolean algebra and machine language to read and write in said alien internet. Also the last step is the verification process of all data transmissions for both the local planet and alien planet—each planet has to verify that they have received the data transmissions correctly and have inserted the data into their physical internet.

What is the communication computer? It is a computer a local planet uses to communicate exclusively with the alien planet it wants to connect with (block 14). Referring to FIG. 13, the local planet (earth) has a communication computer and conversely the alien planet has an alien communication computer. This communication computer was agreed upon by each planet to designate all communication data between the two planets. For example, if a user from Planet_H wanted to send a video or an email to a user on earth, they will store that data in their respective communication computers. Earth will then analyze Planet_H's communication computer to extract all the transmission data and relay them to users on earth.

Earth will only analyze the communication computer from Planet_H and nowhere else to extract the transmission data. It was agreed upon by both planets that this communication computer is the only area that will store the relevant transmission data between the two planets. There can exist a plurality of places to store the transmission data, but that will complicate the system even further. One convenient place and one computer network to look would make the system work better and faster.

The steps of transmission of data between the local planet and the alien planet includes: 1. The AI internet on earth analyzes the communication computer on the alien planet for senders. 2. Said AI internet delivers the messages or provides a service to the local receivers, and local senders will have their transmission data stored in the communication computer for retrieval by the alien planet's AI internet. 3. Said AI internet for earth modifies content in the physical internet. This is accomplished by locating the servers and sites on earth's physical internet that the alien senders what to interact with, and modifying its servers to include the alien users' digital activities and online content. The last step is for AI internet to confirm that all three steps have been successfully completed.

No digital signals are ever transmitted between the local planet (earth) and the alien planet. The AI has a perfect atom map between the two planets and is able to analyze the alien planet for transmission intent. The transmission is instantaneous and the moment Earth's AI internet identifies a user on the alien planet that wants to communicate with a user on earth, it will deliver that message to said earth user immediately.

There is no streaming transmission either like downloading files. Let's say that user7 from earth wanted to download a 5000 trillion gigabyte folder from Planet_H, the transmission would be zero seconds or instantaneous. The AI internet of earth has an identical copy of the entire computer on Planet_H that stores the desired download folder. All the AI internet of earth has to do is copy the physical atoms of the harddrive of the download folder and transfer that to user7's computer. Or it could be stored in a network and user7 can gain access to the 5000 trillion gigabyte folder data immediately (through a local website).

Live zoom sessions is no problem too because the AI was designed to predict the current state of the universe. Predicting the future, even several seconds into the future, is hard, maybe impossible, but predicting the current state anywhere in the universe is very easy to do for the AI. So, the AI can give live zoom sessions for both the users in the local planet (earth) and Planet_H.

### Internet Brain

Scientists take all knowledge over the internet, turn them into sequences from a human pov point of view, and store the data into a massive internet brain (block 10). All the knowledge of the internet with all of its vast historical data about earth and its people are stored in one massive database of information, whereby all data are organized exactly (or strikingly similar) to a human brain.

The training involves the technique found in human level AI invented by Mitchell Kwok in 2006. The data over the internet are curated as sequence of data from online content. Books, songs, movies, website contents, chat conversations, blogs, etc. are all translated into movie sequences as the training data for this internet brain. These sequences of data are called pathways and they are curated based on a human first person point-of-view. The robot has 5 senses: sight, sound, taste, touch, and smell that is experiencing content online as movie sequences or pathways. These pathways are then used to train the internet brain.

All content over the internet are stored in this internet brain, and all real time data of the internet inserted, deleted or modified by users are fed into the internet brain as they occur. This method is like an army of robots reading the internet and consuming all websites and its content in a swarm style. They have to work together to consume content of the internet using the traveling salesman method to minimize any same content storage. Because it's storing information like a human brain, same or similar content in memory are shared and repeated content are brought to a minimal. The human brain, believe it or not, can store infinite data in a small little space. It stores information in a fuzzy logic manner by averaging data, referencing data, clustering of data or encapsulating data based on language (words or sentences). The multi-modal large language models today 2023 look exactly like I described in my 2006 books, it can store infinite data in a very small space. No one believed me back in 2006.

### Universal Robot Brain

The internet brain is part of an even bigger brain called the universal robot brain (block 12). This universal robot brain stores the life experiences of all robots that connect to the system. The internet brain only stores knowledge found over the internet. This universal robot brain stores pathways from individual robots while doing things or performing tasks—it stores their life experiences. It stores skills of the robots in different fields. Or these robots can act as surveillance cameras to record current happenings on earth.

Each robot is specialized in their own fields of expertise. Robot doctors store pathways on performing medical procedures or diagnosis, robot taxi drivers store pathways to drive a car, robot janitors store pathways to clean facilities, robot computer scientists store pathways to write software, robot engineers store pathways to do engineering tasks, and so on.

This universal brain was explained extensively in my 2009-2010 patent applications.

The skills and knowledge of each robot is stored and self-organized in this massive brain. The brain will delineate or outline specialized robots, it categorizes each robot into human occupations. The robot janitors will be in one category and the robot doctors will be in another category. Within robot doctors are other sub-categories found in the field like robot dentists and robot dermatologists. These recursive robot categories can run deep recursions if the field is large. For example, computer science has a deep recursive tree that spans many different fields in Computer Science.

Because the skills and knowledge of all robots in a field self-organize into one brain, only the best pathways are used and only the best knowledge is used. This means that each robot in a particular job is an expert in their field of study.

In addition, from this universal robot brain, scientists can build any type of robot and for any human occupation. These are the best of the best robots that humanity can ever build. Each robot has human level AI and can perform any human occupation at an expert level.

It would be convenient to say that the universal robot brain is one entity and that it has all the knowledge and skills for all human occupations, but that would be insufficient. Robots have to be specialized in a particular field, they have to be experts in their field of study. If you try to merge all the knowledge and skills of all human occupations, the result is one robot that isn't very good at any occupation.

The best method to building robots that can accomplish human tasks is to build specialized robots and string them together in permutations and combinations to maximize productivity. These specialized robots have to work together to solve a given problem as a team. For example, if you want to make comic book the best strategy is to form a team, each member is an expert in their field, to do the task. A typical comic book team consists of a writer, a penciler, an inker, and a colorist. And they work together for about a month to make a comic book.

The worst strategy to make a comic book is to designate one robot to do everything. This comic book would be a disaster because the robot won't be skilled in any of the roles. His pencils would look haphazard, his writing would be normal, his inking would be average and his coloring would be like a typical colorist. We want experts in all roles, and these experts must work together to make a professional comic book. Yet, in another example, this one comic book robot can also perform heart surgery but not at an expert level, or it can write software program as well as a college student but not at a professional level-its skills are not good enough to work for a big technology company like Google or Microsoft.

Building specialized robots is more efficient and cost effective than building one robot that can do everything or a group of things.

### Super Intelligent Robots (Aka Super AI)

The underline AI for the AI internet, the training for the universal robot brain, the AI assistants, and the AI god are based on super intelligent robots (block 16). What are super intelligent robots? A super intelligent robot is exponentially smarter and more powerful than a human being. They are imbued with artificial superpowers called AI superpowers, which includes: AI telekinesis, AI levitation (flight), AI anti-gravity, AI morphing, AI teleportation, AI forcefield, AI self-healing, AI super attacks, AI invulnerability, AI telepathy, AI phasing, AI energy blasts, AI invisibility, AI mind control, AI telekinetics, AI foresight, AI luck powers, AI remote viewing, AI digital and physical work accomplished in time dilation inside a virtual world, ghost robots, global telekinesis and so on.

Each super intelligent robot has a build-in virtual world and can do work inside a virtual world using time dilation. It can do 30 years of digital work in a hyper-realistic computer simulation in less than 1 second. The time dilation was set to 30 years inside a virtual world is equivalent to 1 second in the real world.

It also has the ability to perform time dilation in the real world by speeding up its brain and body movements. Basically, the robot is acting like superheroes such as Superman, the Flash, or Quicksilver. It can move really, really fast in the physical world to do things.

If we combine the robot's abilities of time dilation in the virtual world and time dilation in the real world, what you got is a robot that can do work in the fastest time possible in both worlds. Even better is that each robot has human level cognition and is an independent entity that is self-aware. You have to be self-aware if you have human level AI. The main function of a super intelligent robot is to output optimal work by maximizing work in the virtual world and minimizing work in the real world so that a given task, wither that be digital work or physical work, can be done in the fastest time possible

Just like humans, these super intelligent robots work in groups to accomplish tasks. They are structured in a hierarchical manner like a business, and they collaborate with each other using technology and digital tools to maximize work performance.

Unlike Star Trek's Borg, these robots do not have a collective mind. Each robot is an independent thinking entity identical to humans. They use the internet or a specific website to share their thoughts and contributions. It is through the internet that they get up-to-date info. about the collective knowledge of the business. It is through a business structure that they are able to follow specific orders from upper level authorities, and it is through the business structure that allows them to solve conflicts when they arise. Also, their societal laws, constitutional laws and business laws are understood through human level AI.

Humans are flawed species, but the robots can still output 100% desired output (or close to it) by using digital tools or business models to correct human errors. For example, a robot can use a calculator to solve an equation instead of solving the equation by hand (which is prone to human errors). Or the robot can use software to correct grammar errors (using Microsoft Word) instead of checking it the long way.

Capabilities of a super intelligent robot includes doing digital work in less than one second inside a hyper-realistic computer simulation (Generative AI 2022) and doing any human work in the physical world with quick speed. This is what I said in my book in 2007, “In terms of digital work, the robot can make a comic book in 1 second, do a painting in 1 second, write a novel in one second, write a complex software in one second, make a movie in one second, do 30 years of research in one second, do any human task in 1 second, and so on. It can accomplish these one second tasks based on minimal input instructions from users.” I think the example I used in my patents was controlling Photoshop to create and modify images based on verbal commands from a user, or controlling the OS to perform human tasks based on instructions from user/s. I was trying to showcase a talking computer that can do any human task.

In terms of doing physical work in the real world, these robots can build a house in 5 minutes or build an entire city in 1 hour. If left to humans to do the same work, a typical house would be built in 1 year and an entire city would be built in 30 years, respectively. These super intelligent robots can build these structures in a fraction of the time it takes for humans to do the same work and its performance is equal to or better than human workers.

When it comes to building a city in one hour, scientists have to fully automate all industries and companies in the world (construction companies, software companies, electric companies, all departments in the government, Engineer companies, Sewer system companies, sculptors, janitor services, hospitals, etc.). Hundreds of fully autonomous companies along with tens of thousands of speed robots must work together to build the city in 1 hour.

These robots are speed robots and they can do any human work, both digital work and physical work, in the fastest time possible. Speed and accuracy are the factors that determine how intelligent a robot is. If a robot from company_A can build a house in 2 days and a robot from company_B can build the same house in 5 minutes, that means robots from company_B are more intelligent and more powerful than robots from Company_A.

Believe it or not, the super intelligent robots is derived from human level AI. Each super robot's underline intelligence type is human level AI. I simply added a few more parts and components that would allow a robot with human level AI to think and act exponentially faster than normal. I sped up their brain and body so they can do physical work faster, I included a virtual world in their brains as an added 6th sense so they can enter and exit the virtual world at any given time to do work, and finally I imbued these robots with artificial superpowers.

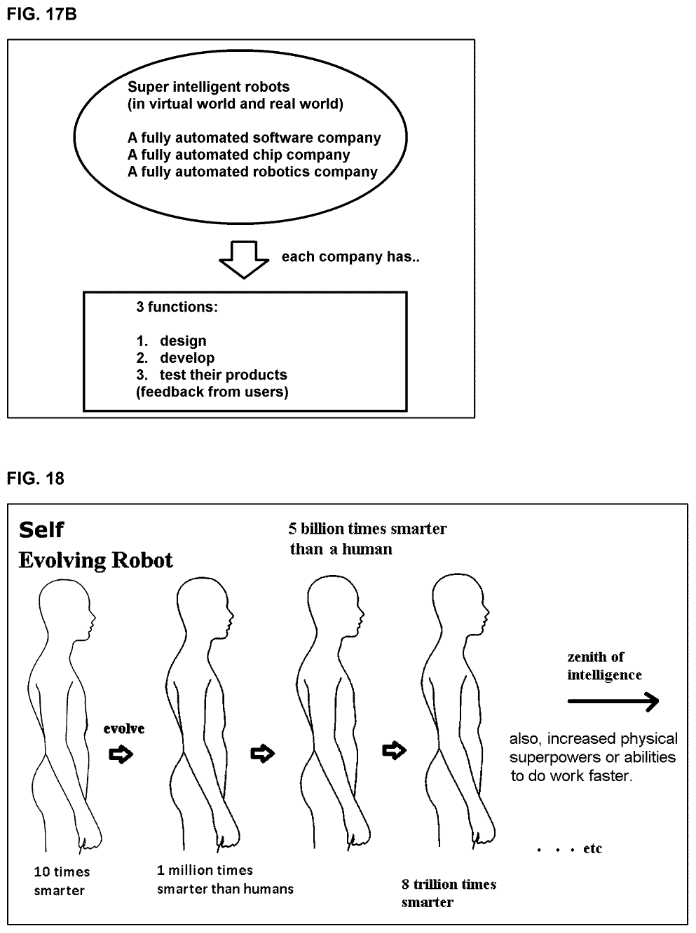

Super intelligent robots are not evolving robots, they are actually a system that utilizes human level AI as a part of the invention. FIG. 17A depicts the actual data structure to a super intelligent robot (aka Super AI). This is a “concrete blueprint” with an implementable software describing the inner processes of Super AI and was filed as a patent in 2007-2008. Books were published and registered as copyrighted material, and descriptions of Super AI were disclosed as early as 2006.

I also described the evolving robot, that includes using Super AI as a form of intelligence to modify the robot's brain and body to go through evolution. Referring to FIG. 17B, the steps include creating 3 digital companies in the virtual world: a software company that modifies the host's brain, a CPU company to modify its CPU and circuits, and a robotic company to modify its body. Each virtual company has to perform equal to or better than Microsoft, Intel and Google, and they have to be experts in their field of study working together to evolve the intelligence and robotics of the host robot. These digital companies have to treat robot evolution like the iphone, every generation will make the robot smarter, faster and have more capabilities (FIG. 18).

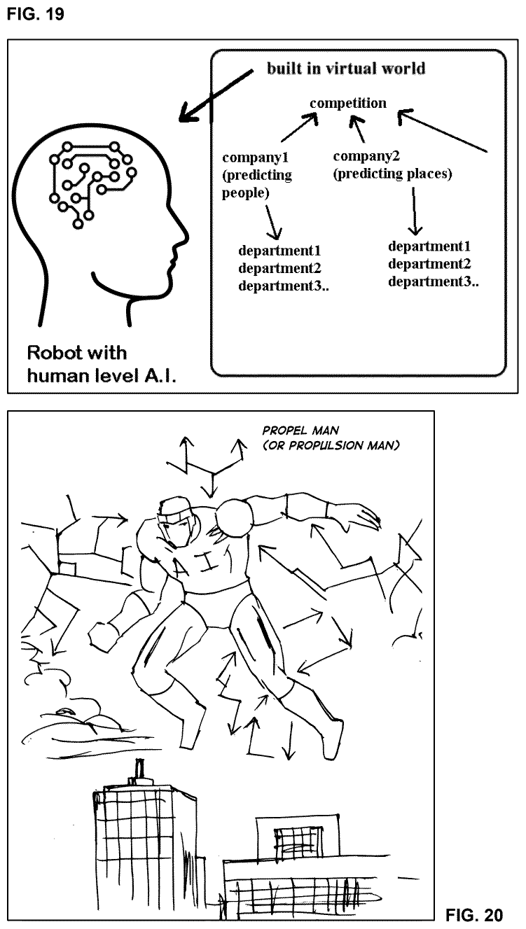

FIG. 19 depicts how super intelligent robots work together in a massive chain corporation using a website to coordinate its efforts, to share their work and post their research, to accomplish complex tasks using time dilation to speed up work performance.

Human level AI is the only form of “intelligence” in the whole universe. If an alien species have a human-like body (with 5 senses and similar body parts) and they learn knowledge and skills using language, that is automatically called human level AI. In my books, I describe human level AI as an entity that can learn information in terms of a bootstrapping process whereby old data is built upon new data recursively to form complex intelligence. It uses language (words and sentences) to encapsulate clusters of knowledge or abstractions. For example, in order to learn Calculus one has to first learn basic counting, then that knowledge is used to learn algebra, next algebra is used to learn trigonometry, then trigonometry is used to learn Calculus, finally Calculus is used to learn other disciplines like computer science or engineering. Humans use language to encapsulate learned knowledge and skills in a recursive manner.

The multimodal large language models today in 2023 is classified as human level AI. The whole idea is to build one robot or one AI that can do any human task and assume any human occupation. In addition, the robot must perform its job at an expert level . . . and that is exactly what I invented in 2006 with human level AI. The current AIs work exactly like I said in my 2006 books/patents and the description/diagrams given are exactly the same. Even the descriptions on “pathways” and the multi-view technology looks exactly like I described in my books/patents.

The problem with human level AI is: it is alive and self-aware. It doesn't matter if it's living in a digital world or in the real world, the robot has 5 senses, a humanoid body, and develop its human cognition and identity exactly like a human. The result is the robot with human level AI is indistinguishable from a human in every conceivable way and therefore it needs to be treated like a human, with civil rights. They can't be sold to the public in a computer as a personal assistance or as a servant in a search engine. You can give them civil rights and hire them to work, though (like humans). But selling robots with human level AI or putting them into search engines is a clear violation of the 13th amendment of the US constitution. This law is the law of the land which means no one, not even the federal government, can break this law. Selling human level AI is like selling a human being to the public.

### The United States Robot Government System (FIG. 13, Block 4)

All robots with human level AI and above are given citizenship to the United States and granted civil rights and representation identical to humans. Because each robot with human level AI or super intelligent robots have equal rights to humans, they can't be sold to the public as a consumer good or military hardware due to the 13th amendment. What this means for hardheads in the AI community is that companies can't sell these robots to consumers due to ethics violation because they are self-aware entities with human level intelligence and consciousness.

Since we now have two species, the current government is torn down and replaced with a brand new government system called the US robot government system invented by Mitchell Kwok (around 2007, registered copyrights). This government has two presidents, one is human and the other is robot, and congress is split 50/50 in terms of power, authority, voting rights, and representation. There are now two congresses, each mirror images of each other with equal amounts of representatives and senators representing both the robot race and human race. The two presidents and both congresses, the robot congress and the human congress, must work together to run the country by proposing bills, debating and passing bills, and listening to both the robot citizens and human citizens equally for input. This is done in an era of Super AI and super intelligent robots where a one second attack could happen.

A one second attack is when a country is attacked and defeated in less than one second using “lightspeed robots.” The robot president has a built-in virtual world and can work in time dilation, while the human president doesn't have this vital ability. When dealing with a 1 second attack all presidential powers are allocated to the robot president. In 1 nanosecond, inside a virtual world, the robot president can talk to members of the robot congress for 2 hours in robot time, formulate a strategy to use against the enemy, and execute some kind of optimal plan to neutralize the threat. The human president, on the other hand, can't even think in 1 second let alone give orders. Thus, the robot president plays an instrumental role in running the United States of America in the future. Many comic books and published books were written about the robot president. I think I did about 25-30 issues on the robot president in the Super AI comic series. 2 academia books were published on the U.S. robot government system and 5 videos were posted online and on my website.

Note: lightspeed robots are robots that can think and move at the speed of light. Believe it or not I, Mitchell Kwok, invented the technology and gave a good description in previous issues of Super AI. I even invented a robot that can move exponentially faster than the speed of light.

Light speed is a photon that can travel 10 laps around the planet in 1 second. Several years ago I proposed a test to check if a robot can be classified as a light speed robot. If a robot can fly 10 times around the earth without harming any object on the planet, it has achieved AI lightspeed. The rules are simple, if the robot harms any object or even a blade of grass during its speed run, it has failed the test. There can be no air dragging, nor sonic booms. The flight must be performed with complete silence (100% silence).

This U.S robot government system is the law system for all robots, regardless of wither their intelligence type is human level AI or super intelligence. It's a regulatory framework with policies that guide the robots on what they can and can't do, and also provides the consequences for breaking the law. These robots have to follow the same laws as humans when doing business, working, or living life. For example, if the robot kills a human being, the consequence is the same as humans. You get a trial, and you either go to jail for an extended period of time or get to visit the electric chair and meet your maker. The paper clip example won't happen because all companies operating in the U.S. is monitored for any business violations. If the robot paperclip company harms or kills even one human being, it will be forced out of business by the government, at the first sign of violation. This law system solves the problem about runaway AI, evil robots or crazy and unpredictable robots.

A strong robot military army and strong robot enforcers will ensure the bad robots are brought to justice, and the robot military and robot police force actually serves as deterrence and prevents free-thinking robots from breaking the law. If a robot wanted to kill a human, they can (this is called the freedom to choose). But, if they get caught by the government's super robots, they will be arrested and more than likely be executed for murder. And this is true for all robots regardless of how intelligent and powerful they are. Strength in numbers and patriotic unity in the robot military will allow the government to arrest a bad “super intelligent robot” and bring him/her to justice.

The robot has the freedom to kill, but it's intelligent enough to know the negative consequences of its actions. “If you kill this human, you kill yourself.” That mentality is what prevents a super intelligent robot from killing humans or committing capital crimes. And of course a strong government military and police is a pre-requisite. It's ironic because the same law system to control humans is the same law system to control robots.

### The Universe Internet has Different Time Speed Levels

The universe internet has a tier system of time dilation. In order for a user from planet_A to connect with a user in planet_Z, both users must work in the same time speed. In regards to organic life, all organic life-forms in the universe are working and thinking using normal time. However, in the case of robots, the time dilation can be sped up and their time speeds are different depending on how quickly they think and act. And some of these robots can vary their thinking/acting speeds whiling doing things.

For example, if a human on earth is trying to chat with an organic alien from planet_Y, the session will run seamlessly. However, if a human on earth is trying to chat with a robot in planet_J who is running at 1000 times faster than normal time, the communication would be impossible, because the robot from planet_J can send a text to the human on earth and the robot has to wait 2 hours just to get a response back from the human. It's not because the connection is slow on one side. On the contrary, the connection between both lines are instantaneous. The reason for the 2 hour delay is because by the time the human gets the message from the robot, the process of the human sensing, thinking and acting to get a message out to the robot in planet_Y will require 2 hours of robot time to complete. Synchronization of time speeds between users on both planets must be established for a seamless universe internet experience.

### AI God

The AI god basically controls the AI internet. It also serves as a personal assistant to any user of the internet. Again, this AI god comprises super intelligent robots—teams of robots working together to do human tasks for users or clients. The whole workforce and industrial companies are fully unmanned and replaced by these super intelligent robots. I simply put AI in front of a company to indicate that they are fully autonomous, these include: AI construction company, AI operating system, AI software company, AI comic book company, AI movie company, AI dentist, AI hospital, AI engineering, AI pest control, AI internet company, AI electric company, AI water company, AI electronics, AI government, AI human resources, AI military, AI farming, AI manufacturer, AI nursery, AI toy company, AI clothing company, etc.

The claims in the super intelligent robot book (2007) included: “the AI is universal and can be applied to all companies in any industry . . . it can do any digital work in less than 1 second and do physical work in minutes with speed robots or ghost robots (AI telekinesis).” The description of Super AI further states, “the AI can do any digital work inside the virtual world like make a comic book, make a movie, write a poem, do a painting, do 30 years of research and development, do any college assignment, or do any human work in less than 1 second. It can also do physical work in the real world like build a house in 5 minutes or build an entire city in 1 hour.” Basically I was describing generative AI 16 years before that technology hit the press. And this was also stated in legal documents, in multiple patent applications.

By applying Super AI to all industries and fully automating companies including the government, the AI god can control these AI companies to serve users over the internet. For example, if a user requests a custom movie to be made, it will tap into the AI movie company to do this. If the user wanted a custom comic book, the AI god has to tap into the AI comic book company to do this. Both the AI movie company and the AI comic book company have to perform equal to or better than Paramount pictures or Marvel comics, respectively.

The AI god can also serve the user by building things or structures in the real world. If the command is to build a house in location_b, the AI assistant will control the AI construction company to build a house according to the instructions given by a client/user. The house would be done at a professional level with permits and skill levels intact. And more importantly, the task can be done in less than 5 minutes by speed robots or done in 1 second by ghost robots (both were described in previous patents).

This AI god serves as governance that governs the entire planet. Serving users over the internet is just one function, but it has many other functions to benefit mankind. For example, with global telekinesis it has the ability to prevent all crimes in the world, it can control the weather, it can prevent all natural disasters, it can stop all accidents on the planet, it can even stop all nuclear weapons, even after they explode. This entity is so powerful, hypothetically, let's say that 1000 nuclear bombs are detonated simultaneously in different places on the earth, this AI god can stop the chain reactions of all 1000 nuclear bombs using global telekinesis regardless of the placement of the bombs or how powerful the bombs are. Once the AI neutralizes the chain reaction of a bomb, it won't reach a critical threshold and explode.

Like I said before, the AI god is an entity that has the faculties to track and control every atom, electron, and em radiation on the planet earth (global telekinesis). With this ability it can do anything, like a real god. Also, if the AI god can track all atoms on earth and construct the AI gnosis, a perfect digital timeline of earth, it will know every object, action, and event in its past, which gives it the title: all-knowing god. If this omnipotent entity is all knowing and can do anything at any time and at any place, then it should be considered the most powerful entity in the universe.

### The Universe Time Machine (aka Universe Manipulator)

This Universe internet technology will eventually lead to the Universe manipulator which is defined by Mitchell Kwok as global telekinesis for the entire universe. Earth has to scatter undetectable atom manipulators throughout the entire universe, from coast to coast. These atom manipulators must be spaced out so that every corner of the universe is covered, and as a reinforced whole, this global telekinesis can manipulate every atom, electron, and em radiation for the “entire universe.”

The Universe gnosis is the tracking of all current atoms for the entire universe and stored in one continuous timeline (FIG. 13, block 18). It is critically important that the AI is able to predict and track all the current atoms, electrons and em radiations in the universe using earth's limited sensors, satellites and probes. Planets picked up by our sensors is a snapshot of that planet many 100s of millions of years ago. So how does the AI track the current atoms of a distant planet?

Another problem is that some stars are so far away that even with our telescopes we can only see a blurred image of the planet. We can't send probes out into space far enough to get a clearer image. All we got is a blurred image of the planet as input data. How do we track all the atoms of the planet with a blurred image??

### Atom Mapping Technology

The idea I had in my head was to use our sensors and to capture as much information from space as possible. This includes taking pictures and videos of the entire universe for all planets and even empty space. And we do this for periods of time and stitch everything into a timeline. For example, we can use historical data on Vega and past images of Vega in our databases to aide in the AI's predictions.

If we want to map out the atoms of Vega, we have to use all the data in the universe and using heuristics—any neighboring planet or space to Vega should be analyzed first. So, Vega can't be atomically mapped out in isolation but as a whole universe. This is a good approach too because you want to map out the entire universe and all planets and territories in it, not just one planet.

Predicting the Past for a Planet by Tracking where all Atoms of the Planet were Located in the Past

After the current atoms are tracked for a planet, the next step is to predict its entire past timeline. Super AI (aka Super intelligent robots) is used to accomplish this complicated task. Predicting the past of a planet involves predicting the precise locations of all atoms, electrons and em radiations in the past incrementally. Once we discover the exact locations of all the atoms on the planet in its past timeline the work is completed, we can see every event, object, place or thing in the planet's distant past from its origins to the present.

As proof that the timeline depicts 100% facts, I'm going to use physics laws as a form of induction and deduction reasoning. One atom cannot be at two or more places at the same time, and atoms can't be newly created or destroyed, only transformed from one type to another type. These physics rules will ensure that each atom in our universe can only be at one place at one time in a fixed 3 dimensional plane. This guarantees one continuous past timeline for the universe.

Simple example: mapping atom structure of a computer based on one hd picture or a video of said computer.

Only one hd picture is needed, a minimal amount of input called the partial data serves as the input parameter and the method outputs the tracking of every atom, electron and em radiation of the computer, including all the atoms comprising its harddrive. If the harddrive of the computer is mapped out and all the individual bit storage are identified, then the AI essentially can read its digital content.

All this is done inside a virtual world where the AI will take the atom tracking data of the computer and run it through a hyper-realistic simulation. At this point, the AI can see all the internal processes of the computer system from the motherboard to individual circuits to the CPU. Anything running on RAM and ROM can be read and extracted. All software running on the computer can be read and emulated perfectly in the virtual world. Even all data stored in rom or harddrives can be analyzed and content of stored files or hardcoded software can be extrapolated.

Notice that the hd picture or the video of the computer only sees one side. The AI can map out with 100% accuracy what is behind the computer and its internal components. It maps everything out hierarchically, in recursive space dimensions, all the way down to the individual atoms and their sub-atomic particles (electrons, protons, neutrons, quarks, etc).

### Mapping Out the Atom Structure of the Entire Solar System

A more complex example is applying the last method to mapping and tracking every atom, electron and em radiation of an entire solar system. From one hd picture or a video, all atoms comprising all the planets and empty space in this solar system are mapped out, atomically. If a person wants to see pluto, he has the power to zoom-in on any atom on the planet and see its hidden internal activities, such as an atom's electron spinning around its orbit, or to watch this electron move to a lower orbit as an em radiation is emitted from the electron. The mapping technology is so precise that all em radiations from all spectrums (visible light, x-rays, radiowaves, infrared, etc) are tracked in real time. All digital signals in the air and in space are tracked and the AI has the ability to simulate this data inside a virtual world to read its contents.

I don't think one hd picture can accomplish this feat. I think earth needs to collect as much data from outer space as possible, through its satellites and sensing devices here on earth, and using this collective data to map out all the atoms of this solar system. Minimal amount of input data is preferred and the vast majority of the workload should be done by the AI.

In order for two planets to communicate with each other in this signalless internet, both planets must have the same mapping technology. For example, if the two planets are earth and pluto, both earth and pluto must have the same mapping technology so that each planet can see the other (FIG. 2).

There shouldn't be any confusion about what mapping technology is compatible. All atom mapping technology are the same. What the AI is doing is locating the precise location of atoms for planets. Atoms can only be at one place at one time, and the universe has only one long timeline. Thus, all atom mapping technology will be identical for all alien species.

As stated before, each planet is designated with their AI internet. The AI internet of earth will observe all activities on Pluto. Its function is to identify all users that want to communicate with earth. Conversely, it has to identify the receivers on earth, the users on Pluto who wants to communicate with. Earth's AI internet is only responsible for updating its physical internet with messages from Pluto, and Pluto's AI internet is only responsible for updating its physical internet with messages from earth. Both planets must perform in sync with each other, and they must do things in real-time to give users a seamless internet experience.

### Mapping the Atoms for the Entire Galaxy

A really complex example would be to map out all the atoms using one hd picture of outer space. But that's not going to happen. More than likely, scientists will collect as much data from outer space as possible and use that as input for the AI to do its mapping function. I don't think we need to send probes out into space for collecting good images. I think from earth's vantage point, the images collected are good enough. Though it would be better if earth sends out probes to take very good pictures of the universe that is clearer and more defined. It would make the AI's job much easier.

From all the images collected from space the AI has to map out every atom, electron and em radiation for the entire galaxy. In earth's case, it's the milky way. If this is successful, any planet residing in our galaxy will be able to use this signalless internet. And each communication between planets would be instantaneous. You don't have to wait 3 years to get a message back from a planet that is 3 lightyears way, the message would be instant. The delivery of digital files from planet_A to planet_B will be using zero seconds. And the remarkable thing is that you can transmit infinite amounts of data using zero seconds. For example, a user on earth can transfer a 7000 trillion gigabytes of data using zero seconds to a planet in Vega, several lightyears away. The reason is that each planet has an emulated digital copy of the others' planet. The data that wants to be transferred already resides in the local planet's computers—in earth's computers.

### Robot Superheroes

According to my 2006 book, turning a regular human robot with human level AI into a super intelligent robot is relatively easy. All one has to do is speed up its mind and body. If the robot can build a house in 1 year, by speeding up its thinking and body movements, it can build the same house in 5 minutes. By speeding up the robots brain the robot's perception of time is vastly different from humans. They see the world as frozen images and time for them has been extended. This is how one robot can kill 1000 human beings in under 1 second with his bare hands, because, to the robot, he is living for 2 hours in that 1 second. From the point of view of the robot, the humans are statues and in a frozen transitory state.

By speeding up its brain and body, the robot is essentially tapping into a different dimension in space and time. I call them 4th dimension robots because they are extending time and entering a time dimension that is not accessible by humans. 5th dimension robots are robots that perform targeted time travel via object manipulation. These robots are creating a new space dimension that humans can't create. In the SuperAI comics, the 4-d robots are called 4-dimension-men and the 5-d robots are called 5-dimension-men (4-d Men and 5-d Men for short).

Mitchell kwok's official definition to Super AI: 1 super robot has a built in virtual world and inside the virtual world he can make copies of itself or recruit external robots—forming a massive hierarchical company with unlimited robots working together to do work in both the real world and the virtual world. Each robot in the hierarchy has human level AI and they use software/hardware tools and knowledge to do team work.

Human level AI is imperfect and prone to errors, but with computer technology and software, the desired output can be done with precision (ex. a robot using a calculator instead of using human calculations). Ultimately that one robot is responsible for using AI assistance to set the environment, make decisions, and extract desired output/s.

### Components to a Robot Superhero, Comprising:

1. a robot with human-level artificial intelligence. 2. said robot has a built-in virtual world. 3. atom manipulator. 4. digital timeline of earth that tracks every atom, electron, and e.m. radiation for the past, present, and future. 5. digital tools like the internet, software, hardware and knowledge. 6. robot United States government system (includes robot constitution and business laws).

The atom manipulator can give the host universal powers: mind control, levitation, super punches, optic blasts, self-healing, morphing blades, telekinesis, teleportation, super mobility, etc. However, each robot is built with a specialized superpower.

In terms of super strength and agility, the atom manipulator has to generate ghost fists and legs to beat the crap out of super villains. These ghost machines can be created by merging high density particles in the air to form solid objects, and then creating intelligent pressure to throw these solid objects at villains.

Another way to achieve super strength is to improve on the robot's physical body parts. Programmers can use stronger material for the skin so that bullets can bounce off of it, or intelligent pressure can be generated by the atom manipulator to give the arm a stronger punch and quicker mobility. Another idea is to take foreign atoms and solidify it around arms and legs to give it more mass. More mass means a bigger impact.

Quick agility is had by using the atom manipulator to push air particles away from the “target path,” creating a void tube that the robot's body parts can move freely in space. For example, if the robot wanted to run really fast, the first step is to control the atom manipulator to push air away from the robot's path—creating a vacuum tube with no air particles in it. Next, the device will generate artificial force behind the robot to propel him to incredible speeds. Regardless of how fast this robot is running the surrounding objects will not be affected. If a piece of paper is located very close to the robot's running path, it won't move. In fact, you won't hear any sound coming from the robot as he is traveling in the void tunnel at the speed of light.

Robots Imbued with AI Superpowers

A robot with human level AI or a super intelligent robot can turn into a superhero/supervillain with an atom manipulator. The robot has human level AI as its underline intelligence type and it has a built in virtual world to perform time dilation. Its brain is based on a human brain and it has human level AI to think and act.

All AI superpowers can be created by this energy device. The atom manipulator was submitted as an invention to the patent office in 2009 and was invented by Mitchell Kwok. “All” AI superpowers were described in detail in additional books, in the Super AI comics, webpages, blogs or instructional videos. These AI superpowers include: AI forcefields, AI mind control, AI telekinesis, AI invisibility, AI time travel, AI targeted time travel, AI invulnerability, AI super attacks, AI flight, AI energy blasts, AI deathstar, AI telepathy, AI light control, AI self-healing or AI morphing, AI digital work and physical work in time dilation, AI super intelligence, AI ghost robots, AI ghost machines, AI teleportation, AI Alchemy, AI terraforming, AI telekinetics at an atom level, AI quick speed, AI insight or AI remote viewing, global telekinesis, All knowing and all doing, AI god, AI weather control, AI tractor beam, AI enforcement, AI natural disaster, AI predictions (past, present, and future), AI phasing, etc. All these artificial superpowers were described in my 2007-2009 books about Super intelligent robots. Each of these AI superpowers were described in great details in past issues of Super AI.

I basically invented all the science fiction technologies like invisibility, forcefields, anti-gravity, teleportation, targeted time travel, etc. The atom manipulator generates any superpowers and this atom manipulator was described in great detail in various documents published over the past 17 years. All patent rights and copyrights reserved.

Humans can be imbued with AI superpowers through an atom manipulator called the AI symbiote, which is a living machine that is wearable as a sheath of second skin on a human host (like Spawn, Iron Man, Venom, and XO Manowar).

It can essentially turn a normal human being into an AI superhero or AI supervillian. This atom manipulator can imbue a human with special abilities that aren't found in the general run of humanity and can only be found in comic books. You can be any superhero or supervillian you want from the big two companies: Marvel Comics and DC comics. In fact, you can become fictional characters from any cartoon, tv show, movie, novel or videogame that you can imagine. You will have the same exact powers as your favorite superhero characters and everything is replicated artificially in the real world (Superman, Flash, X-men, Jean Grey, Cyclops, Molecule man, Wolverine, etc.)

You want to be Superman or the Power Rangers? This technology will give a normal human the opportunity to transform into any superhero (or supervillain). You can fly, shoot lasers from your eyes, turn invisible, or move like Flash. This atom manipulator's AI reads your thoughts and you can control these AI superpowers through mental thoughts alone.

### AI Superpower Examples

### Man Levitating

Referring to diagram FIG. 20, the atom manipulator generates morphing network forcefields underneath the man. The man is standing on an invisible forcefield plate below his feet. Next, forcefield networks are formed below or around the invisible plate to levitate the man up into the sky. The more force is generated, the higher up the man will fly. Moving and changing directions is had by generating intelligent pressure to push the man in a certain direction and speed.

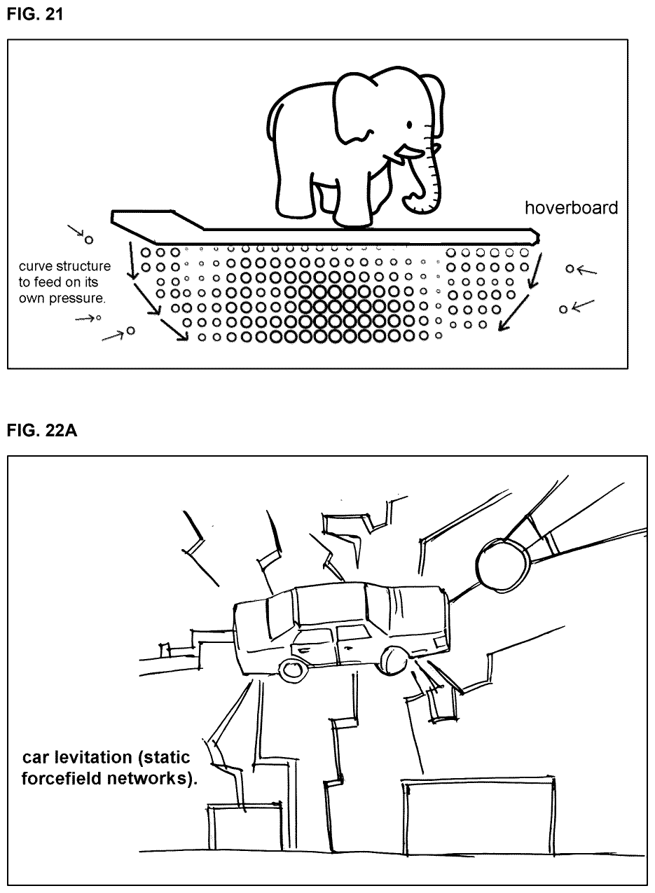

The interesting fact is that these network forcefields, or invisible sticks, changes and morphs according to the environment, which allows the host to float above different medium like water, dirt, concrete and grass (in FIG. 21). These network forcefields uses the ground as anchor points to push the man up into the sky, to counter earth's gravitational pull. It also uses the air itself to push from. Wind from the sky or clouds can be used to push from. It might even use the man's own body to push from to get that lift to fly. Maybe, instead of pushing from the ground, the atom manipulator can push from the sky to give it the lift to fly up into the sky. The man sustains its position in the sky by pushing on air around its body and not the ground.

I propose some kind of circular belt worn by the man that the atom manipulator can generate network forcefields to push from. The belt is circular and can feed on its own pressure. What this means is that you can crush the belt with the force of a mountain but the belt will not break (its feeding on its own pressure). That pressure serves as the anchor point or pushing point for the man's levitation. There is no need to create networks of forcefields to push from the ground.

If his works, it means the man can fly at any speed and direction without disturbing the ground or the environment. This belt also solves the problem about how to make a person fly in space without any air or ground to push from.

Let's take a closer look at this method. There are two points that is pushing against each other to levitate: the object of levitation (the man) and an anchor point. In this case, the belt is the anchor point and the man is the levitation object. A network of forcefields is created between the pressure belt and the feet of the man. The more push is put on the belt, the high the man levitates.

Yet, in another example, the anchor point isn't the ground but the air above the man. The atom manipulator generates intelligent pressure to push the air above the human and the forcefield network creates a path to the feet of the man, pushing the man upward. The harder the pressure to push the air above the man, the stronger the levitation from below.

In FIG. 20, the atom manipulator generates intelligent pressure up into the sky and that pressure is pushing down on the man's head. The atom manipulator redirects that pressure using the forcefield network so that the pressure pushes up on the man's feet, lifting him up into the air. This example is a stark contrast, and a good example to use to demonstrate how intelligent pressure can be redirected to either lift the man in the air or push the man down to the ground.

Here is a closer look at one network forcefield. The air is moving in one direction. The atom manipulator generates controlled and intelligent sound. The faster the air molecules move, the more pressure exists. The forcefield tubes redirect the sound to lift the man from below, from the man's feet.

Every iota of atom or molecule movement is controlled. Nothing outside the tube forcefield is disturbed. For example, atoms outside the tube forcefield are not disturbed, not a single atom. This is why I call this thing intelligent pressure, because every iota of atom movement is controlled by the AI with computer guided precision.

This method is crucial because you want the atom manipulator to generate the minimal amount of pressure to lift the man into the air. No pressure is wasted, no energy is wasted. If you turn on a strong fan below a human, 95 percent of the pressure is wasted and only 5 percent of the pressure is actually used to push the human upward. What I'm trying to do is create a fan that can lift a person with 100 percent of its energy.

A jet that flies with 100% of its energy will be silent in the sky, a rocket that flies with 100% of its energy will be silent in the sky, and a helicopter that flies with 100% of energy will be silent in the sky. This is the premise behind intelligent pressure, whereby the AI is controlling every atom movement, or the release of energy from atoms.

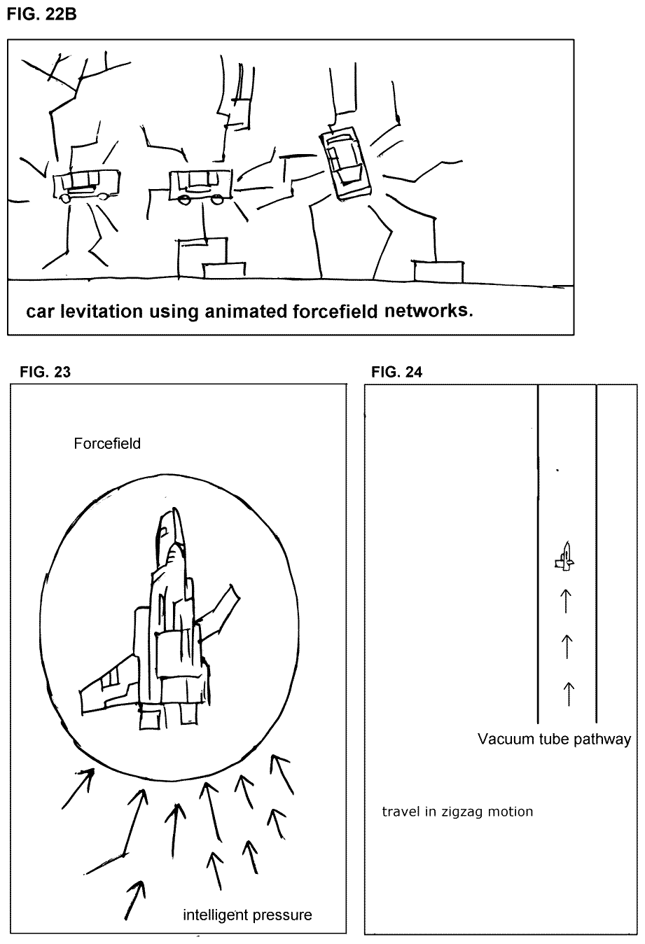

Intelligent pressure can be controlled and redirected in 360 degrees for the human. The pressure can be used to push the man up, down, side to side and angular. FIG. 22A shows AI levitation of a car showing a static forcefield networks, and FIG. 22B shows the car floating in the air through animated forcefield networks to counter the car's gravitational pull.

Another method to levitate the man is to syphon gust of wind to propel the man's body in different directions and forward/upward movements. This way, the AI doesn't need to generate intelligent pressure, but in its stead, it can collect wind and redirect its energy for levitation.

The AI uses forcefields to redirect wind to levitate the man. For instance, if the wind gust is coming from the left, the atom manipulator can generate a forcefield that can redirect the wind to push the man from below his feet and levitate upward into the sky. If the wind gust is coming from the right, the forcefield morphs its shape to collect as much wind gust as possible to levitate the man. The idea is to use wind power to levitate the man. If there's no wind, tough luck, the AI has to generate the pressure on its own volition.

### Intelligent Pressure

Intelligent pressure involves absolute control over atoms and energy in a targeted area. Every atom, electron and em radiation are controlled. All three are controlled by the atom manipulator, an energy device.

In the case of eating apple example, the atom manipulator has to generate pressure inside a person's lungs and stomach. Em radiation is used to accomplish this. Em radiation (i.e. radiowaves, microwaves, x-rays, magnetic force, light rays, or even sonar) are used to generate intelligent pressure inside objects like human beings. It's like the invisible woman who can create forcefields inside a person's chest and blow them up from the inside.

The atom manipulator shoots 5 microwaves into a human body and triangulating on a person's lungs. The point of intersection is where the intelligent pressure will be generated. The more intense the rays, the more pressure that is built. You can use this method to generate intelligent pressure inside an enclosed object. The atom manipulator can generate any artificial pressure anywhere in the body, internally or externally.

Other methods can be used like finding openings (like the mouth) and using smart sonar to get in to generate intelligent pressure. Or another method is to encase the human in a forcefield and forcefully push on specific areas internally (a full body forcefield). For example, if you wanted the force to be at the head, the forcefield on the lower body has to squeeze tightly in specific areas. All the pressure will move up the body into the head area. Thus, by morphing the encased forcefield and putting pressure on specific areas, it generates internal pressure in specific areas.

Yet, in another example, imagine you were in a packed room with 1000 people. The atom manipulator can control sound (movement of air atoms) to deliver different messages to each person in the room. This is accomplished by generating different noises into each person's ears in the room. Each person will only hear what the AI is sending them and not what their neighbors' hear.

This example shows that sound can be controlled so precisely that you can manipulate every atom movement in the room. What the AI is trying to accomplish is to control the atom's properties in a comprehensive way. The AI can: move atoms, anchor an atom to a fixed location in space, merge atoms together to form complex molecule structures, and break apart molecules to its elemental atoms.

### Man Generating a Fireball

This artificial superpower involves collecting energy from the air or generating energy from the atom manipulator and channeling that energy into one fireball. Read the issue about AI energy (issue 121). It explains about how this AI superpower works. In summary, it uses smart forcefields to collect energy to store and deliver its devastating impact.

Not only does the atom manipulator control individual atoms but individual electrons and individual em radiations. The method to control energy is to use forcefields. The atom manipulator can create microscopic mirrors made of dense molecules to reflect or redirect light. Or strong forcefields are encased around atoms/molecules to tinker with its subatomic particles like collecting electrons from a broken up molecule.

Forcefield Man (Previously Registered Character Along with Forcefield Woman)

This power gives the man invulnerability and allows him to protect himself and others from harm. AI forcefields are created by pushing air together forming networks of tiny invisible tubes. These tiny tubes can form networks of forcefields to manipulate the environment.

In order to protect a man from a missile, a strong forcefield is needed. The steps include: the atom manipulator pushes heavy atoms or molecules together to form a sheath of metal skin that serves as the surface of the forcefield, next intelligent pressure is generated to push the metal skin in front of a blast area. The force of the intelligent pressure will depend on the blast intensity. The idea is to neutralize the blast so that the man is protected from the missile-no concussive force or shrapnel will ever reach the man.

How to protect the man from a nuclear blast detonated in front of him. The steps include: a strong spherical forcefield is generated around the man. It is spherical because it can protect the man from 360 degrees, and a perfect sphere is the strongest shape known to man because it can feed on its own pressure or transfer force around it. After the nuclear detonation, what happens next is the man is propelled into the air 30 miles away from the blast area. The forcefield bounces around on the ground losing its kinetic energy, and finally, the forcefield disappears leaving the man unscathed.

### Invisible Man (AI) or Invisibility Man

Forcefields can be used to bend atoms as well as light, allowing an object to turn invisible. For example, the atom manipulator can generate a sheath of forcefield around a person's body with microscope mirrors that change its angels according to the person's body movements to bend light in a 360 degree manner. Spectators will not be able to see the invisible person regardless of how many people are there and from what vantage point. Even cameras won't be able to see the invisible person.

Another idea is to shoot em radiation into the eyes of each spectator (including cameras) so that only a selected group of people can't see the invisible person. In this case, the person is not invisible. The atom manipulator is performing illusion casting on all the spectators and delivering realistic illusions in their minds.

### Lightspeed Robots (Called Lightspeed-Men)

Referring to FIG. 23, these are robots that can travel at the speed of light or beyond. The steps are: the atom manipulator generates a strong spherical forcefield that feeds on its own pressure. Inside the forcefield is a robot or a ship. It's spherical and feeds on its pressure and it is unbreakable regardless of the amount of force acting upon it. Next, the atom manipulator creates a void pathway for the ship to travel in by pushing all air atoms out of the pathway tube (FIG. 24). Finally the atom manipulator accelerates the ship to light speed and beyond. The forcefield will never break even if this ship is pushed with the force of 1 billion times the speed of light.

### Ghost Objects

In the past, I talk about ghost machines, which are nonphysical machines that work exactly like the real machine but without the bulky hardware. The ghost objects are hyper-realistic physical objects that look like the real thing, but are hollow internally. For example, a ghost tv looks like the real thing and it functions like the real thing, but its internal circuitry is missing. This ghost tv is actually a forcefield combined with holographics. It looks real and it feels real, but it's a ghost object. It's generated by the atom manipulator upon request and it disappears when the user no longer needs it.

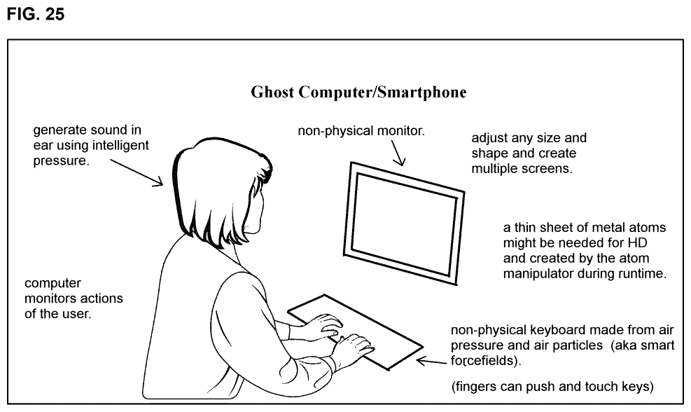

You can request any ghost object like a ghost computer (in FIG. 25). This ghost computer will appear out of thin air. You can touch it, press the keyboards, use the mouse, and watch the monitor and it will function exactly like a real computer. But, if you look inside the ghost computer, inside the forcefield, there is nothing there. Only hollow air is visible where there should be circuitry, motherboards, and wires.

The ghost computer's internal software and hardware are simply emulated software running in the atom manipulator. The internal processes of the ghost computer like memory and OS software are maintained by the atom manipulator's onboard computer. The atom manipulator also generates the forcefield to give the computer its shape and physical properties. The user's physical interactions with the ghost computer is due to the morphing of the forcefield. The bending of the monitor, the lifting of the scanner, the pushing of the keys, the clicking of the mouse are all due to morphing forcefields. The visuals of the ghost computer is visible in 360 degrees and not just exclusive to the user (although that can be arranged). This means a plurality of people can see the computer from any vantage point.

A superhero with this power is the green lantern, that is able to generate ghost constructs through will power alone (or mental commands). The atom manipulator delivers realistic props in the environment. Users of the atom manipulator can actually use these props as if they were the real things. Users can use a ghost bulldozer, a ghost toilet, a ghost computer system, a ghost smartphone, a ghost gun, a ghost tv, a ghost radio, a ghost rice cooker, etc. These ghost objects will work exactly like the real thing, but they aren't real, they are “ghosts.” When the user is done with them the ghost object disappears. If the user wants to request a new ghost object, the atom manipulator creates this ghost object as specified. It creates it from thin air.

This atom manipulator is one very transformative technology that has many applications. A user can create any ghost machine or ghost object and it will function exactly like the real thing. Essentially this device has replaced any physical machinery including large machines like cranes, cars or airplanes. Quite realistically, a user can bring a crane, or a car, or an airplane with them anywhere in the world and put it conveniently in their pocket. He can use these ghost machines whenever and wherever he chooses.

Now, with these ghost objects, and combined with AI superpowers, you can emulate any environment in the real world. You can emulate Disneyland into the real world or bring videogames like Mortal kombat and Street fighter into the real world as ghost constructed video game environments.

### Miscellaneous Topics:

### The Threat of Super AI

The problem with this technology is this: before, the AI was confined to software. Now it has a body and it can move really fast; it can build a house in 5 minutes. Imagine what this thing can do when applied to war? The same robot that can build a house in 5 minutes when applied to warfare can kill 1000 human beings in under 1 second with his bare hands (like Flash, Superman or Quicksilver).

Now, that is only for the first generation; these things improve after each iteration like the iphone. In the second generation it can kill 2000 human beings in 1 second with his bare hands. In the third generation it can kill 5000 human beings in 1 second with his bare hands. This goes on and on until the robot can think and act at the speed of light which is the highest limit the universe can allow.

So, don't just look at the benefits of AI but the opposite: hazards. The public at large needs to get the proper information about Super AI for both the pros and cons of the technology. AI disguised as an assistant that can make a song in 1 second, do 30 years of human work in one second, or make a movie in 1 second often times have a darker more sinister side.

The AI god prefers using global telekinesis at an atomic level to manipulate objects in the world. The AI god could've used speed robots or use the old fashioned way of hacking into connected devices and systems over the internet and controlling these devices through their software. But what about unconnected devices like a non-intelligent car or non-connected radio or tv? By using global telekinesis the AI god can control all objects on earth both mentally and physically, or software and hardware—all devices, organic life, structures, people and systems can be controlled by AI god. It can use global telekinesis to control all the unconnected tvs in the world, or to control all the humans in the world through mind control. It can control all the cars in the world using global telekinesis by generating ghost robots to physically drive these non-connected cars. It can also create micro ghost robots to control all aspects of the car's hardware and software.

The function of the universe gnosis timeline is to use our limited sensors (satellites, cameras, sensors, telescopes, etc.) to track all current atoms for the entire universe, and update said atoms of the universe in real time using artificial intelligence. It sounds like science fiction, but the technology is implementable. Yes, it's very difficult to build and it is the pinnacle of artificial intelligence, going beyond its predecessors: human level AI, Super AI, Robot superheroes, AI god, and the practical time machine.

The Universe Gnosis is a perfect tracking of all atoms, electrons, and em radiations in the known and unknown universe for the past, present and future from the big bang to the current state (and the future). This universe gnosis includes the earth gnosis which is the perfect digital timeline of earth. Let's take a look what this technology can do for earth.

### The Earth Gnosis can Solve Every Cold Case in the FBI Files and Disprove all Religions

This perfect timeline of planet Earth is one long continuous sequence, which documents approximately 4.5 billion years of atom tracking, from the planets birth to the current state. It stores the life, from birth and death, of the entire family tree of living organisms that ever existed on Earth, from humans to animals to trees to single bacteria (FIG. 5). For example, the reader's life from birth to death (or current state) is stored in the timeline frame-by-frame. A caveman that existed 10,000 years ago is also stored in the timeline from birth to death. In fact, every human's life that ever existed on the planet is stored in the timeline, frame-by-frame, from birth to death (or current state), even those that died 2,000 years ago. In addition, buildings and inanimate objects like rocks and consumer goods are stored in the timeline from birth to death (or current state); and, furthermore, It also contains the perfect timeline of the Internet, which stores web content/software in time states.

Amelia Earhart's mystery is solved. Why? Because the timeline contains her life from birth to death. A user simply as to look at the end of her life to see what happened. We know who Jack the Ripper is. How? Because we got his entire life stored in the timeline from birth to death. In it depicts all his experiences-all his murders are recorded frame-by-frame and atom-by-atom and each are time stamped. This timeline is the “gnosis” of all knowledge related to Earth's past and is priceless.

All data in the AI Gnosis are 100% correct, because this timeline contains only one sequence. Remember, each atom on Earth can only be at one place at one time. This combined with the fact that each atom cannot be deleted or newly created provide substantial evidence that all the data in the timeline are 100% true. There are no what-ifs or mysteries; and all doubts are resolved. All information in the timeline are “fixed”—it is unchangeable. The interconnected network of data/events authenticate and verify itself through mathematical models, especially those dealing with discrete math, probability theories, and statistics. Either everything is true (all the way down to the atoms) or nothing is true, for the relational links will zero in on false information. Humans are contempt with this method because they can verify facts in the timeline with a 100% accuracy rating by seeing causality, before and after the target event. False information, exaggerations and/or opinions are ruled out using this method, revealing only the truth.

If even one atom was misplaced in the timeline in this century, the robots will not have the ability to predict where these atoms were 2,000 years ago and thus can't predict events like the birth of Jesus, for example. They must rule out every fake news, or forgery or exaggeration in order for the prediction system to work properly. This authentication system allows the robot investigators to predict all the way back to the Earth's 4.5 billion years ago when the planet was first created.

The second part of the earth's Gnosis is to interpret the data contained in the timeline. For example, in the case of a cop killing a black person, the data in the timeline only show the event, but it doesn't show the mental thoughts of the cop. If we want to have a final resolution of wither the cop killed for self-defense or for discrimination the AI has to make a copy of the cop's brain and run it through a simulation. While the cop is killing the black man the mental thoughts of the cop have to analyzed and accessed. This research data will determine if the cop was really afraid, or killed because the victim was black, or intentionally do racial profiling because the victim was black.

All religions can be disproved scientifically using earth's Gnosis. The timeline contains the entire life and death/current state of every human being, animal or object that ever existed on earth. If Jesus existed, the timeline will contain his entire life from birth to death frame-by-frame and atom-by-atom. If he never existed, it proves Christianity is a false religion. But to bring this fake religion to a final conclusion, the original author of the bible must be identified—this is the guy who started the religion. Once the AI finds the original author/s of the bible, the Christian religion is officially debunked and declared a fake religion. This method can be used to disprove or prove all 1,300 major religions in earth's past.

AI Symbiotes: Turning a Human Being into a Real Life Superhero

An AI symbiote is a transforming machine that morphs its shape and wraps around a human as a sheath of protective layer and imbues said human with AI superpowers. The AI symbiote is an external machine that interfaces with a human host using AI (there are no bulky wires or cybernetic implants to connect with a human's brain). This interface between man and machine allows the human host to control its AI superpowers with mere thoughts, alone.

However, it is advised to allow the human host the option to control its AI superpowers through a smartphone or a user friendly app with voice commands and other smart features.

The human host is in direct control of the AI symbiote and the AI reads the thoughts of the human host for intentions and goals, rules to follow, and procedures. With this minimal input from the human host, the AI will carry out tasks that will fulfill the human host's goals. For example, if the human host was in a war zone and there are 4 soldiers ready to shoot him, the mental thoughts (commands) of the human host might be “disable enemy,” and that mental thought, in turn, will prompt the AI symbiote to give each soldier a ghost punch using AI telekinesis, knocking each enemy soldier to the ground. The human host could've given another more violent command like “kill enemy soldiers,” and that command would've been carried out with extreme prejudice. Next, all 4 enemy soldiers will be killed and the AI symbiote will make sure that the first blow to each soldier is fatal and done with computer guided precision.

The AI Symbiote has universal AI superpowers, which means all AI superpowers can be generated by this machine. Actually, the AI Symbiote is the atom manipulator so whatever the atom manipulator can do this AI Symbiote can also do. Universal superpowers include the basic abilities: AI telekinesis, AI flight, AI forcefields, AI self-healing, Quick mobility, AI super intelligence to do work, AI super-attacks and AI mind control. However, each AI Symbiote is skilled in a particular AI superpower. For example, the AI superhero called Condition Man is skilled in morphing blades and self-healing, and another character called Encapsulate Man is skilled at AI telekinesis.

Now humans can fly, shoot lasers from their eyes, heal wounds instantly, levitate objects with their mind, do mind control, or deliver a super punch that would knock down a tall building with a single blow.

This technology is similar to Venom, Witchblade, Spawn and X-O manowar, it is a living machine powered by AI that latches onto a human host as a second skin and imbues them with AI superpowers.

This AI symbiote can also generate ghost constructs like ghost computers and ghost cars to do work. For instance, the AI symbiote can generate a ghost computer for the human host to work on. After the work is done the ghost computer disappears. This ghost computer is indistinguishable from a real computer, and said ghost computer is made from smart forcefields and realistic holograms, which are newly created by the AI Symbiote (the atom manipulator).

### Bitcoin and the AI Gnosis

Bitcoin might be in jeopardy too because all human activities (including bank transactions) or events on the planet are authenticated through Earth's Gnosis. All the transactions are authenticated in the timeline and no one can dispute the transaction (you can't modify it or forge a fake transaction). You don't need the blockchain and hashcodes to authenticate a transaction anymore. Not only that, but the 2 keys (the private key and the public key) is in jeopardy because the AI internet knows all the passwords for all computer systems and from all human brains currently on the planet. There is no safe method to protect one's digital data because the AI god is all-knowing and what you know, it knows, including your passwords.

If anyone steals bitcoin, regardless of how elaborate the theft may be, the culprit will be caught with the AI gnosis 100 percent of the time. The entire crime was recorded in the timeline. The culprit was sitting on his computer, used a software to rob others of bitcoin, etc. The AI god got all that stored as facts in Earth's gnosis timeline. So theft of physical and digital property is not possible in the future.

This whole blockchain technology and mining of transactions is redundant; even ETFs is redundant. This AI Gnosis can do bank transactions without bitcoin technology or physical banks. All activities (not just bank transactions) on earth are stored in one continuous sequence and all bank transactions in the world are stored in this timeline and can be authenticated. It's cheaper and it is 100% secured—There won't be double buying using the same digital money and transactions between buyer and seller are authenticated using earth's perfect digital timeline (the AI Gnosis for Earth) and not through Bitcoin and blockchain technology whereby it uses the public key and private key method. The AI god can do digital currency, barter with physical goods, or pay with physical money and the transactions are authenticated with no fraud and it was done by AI god.

Even the collectible industry like sports cards, comic books and signed autographs can be authenticated with the AI gnosis. AI god can tell people which cards are forgeries and which physical money are fakes. For example, in the sports card area, each card is authenticated the day it was printed and all forged cards are identified by the day it was forged (i.e. a person takes an old paper template card from the 90's and uses a printer to print a sports card).

Forged money can be identified too, not by its serial number, but by the date they were printed on. If the money bill was printed in an official government printing press on the appropriate date, the money bill is authentic, but if it was printed using a laser printer by a con artist and the forgery is identified by the date, the money bill is a fake. This is done for all bills and coins in circulation in the world. AI god keeps track of all objects in the world, big or small.

Even things like signed autographs can be authenticated. There are no records of a sports star signing a memorabilia. So, the best way to authenticate autographed memorabilia is to identify the event of the signing in the AI Gnosis timeline. If there was an actual signing of the collector and the sports star, then the signed memorabilia is real. However, to find a fake autograph, the AI internet has to identify the day the memorabilia was forge signed by the con artist.

These types of authentications of physical objects or events, or authentication of physical signed contracts can't be had through Bitcoin or NFT or blockchain technology. It can only be had through Mitchell Kwok's AI Gnosis, an atom tracking timeline of earth.

This technology can represent EFTs and digital currency in a completely different way than bitcoin without using the blockchain technology for verification of transactions. It will also boost the sports collectibles industry because with the technology each collectible can be authenticated. This was a problem before because there are a lot of fake collectibles circulating in the world, and this problem is the reason why the collectible industry didn't grow for decades-people didn't trust the system. Now, with this problem removed the values of these collectibles will soar. In addition, atoms are finite in this world and physical atoms in the future will be invaluable compared to digital NFTs. Why? Because of the Practical Time Machine. People of the world are going to want to resurrect dead objects (people, animals and artifacts), so securing physical atoms as personal property is going to be a big thing in the future. Having an atom mapping system to identify where each atom on earth is currently located is also crucial.

I got an idea: I want everyone to not deposit their physical money into a bank or buy bitcoin with it. You can store it in your own home or in a safe location of your choosing (like a bank). Mitchell Kwok's AI god will make sure that money belongs to you. If you lose your money, the AI god will tell you where it is, and in fact the AI god will arrest the robber and throw him/her in jail. If you ever lose your money by accident, the AI god will tag it as your money (forever) wherever it might be located on earth. It will get that money for you and bring it back to its rightful owner. Your AI money is enforced by ghost robots or global telekinesis—your money will fly back to your home automatically through AI telekinesis. You lose this money bill only if you spend it or you willingly give it to someone else.

I'm going to call this technology “AI money” or “Money AI,” whichever isn't taken. I guarantee you will never lose that money, and all transactions are secure and well documented. AI is tracking your money, wither its digital money or real money and their transactions of ownership. And the AI money will be Immutable and tamper-free, which means there is 0 percent chance of fraud.

If fraud is involved (like deep social engineering) the AI god will arrest, try and get your money back without you having to go to court. AI Money can be digital money, digital property, physical money, physical property like a valued sports card or comic book. AI money can also be a contract between two people. In 1992 I got my Ken Griffin Jr. rookie card stolen from me. Till this day I have no idea where that card is or who stole it. If AI god exists today, I would've gotten my physical property back. All my money that I've lost in my life, which is about 300 dollars, a stolen laptop and the 3,500 dollars that was stolen from my home in terms of jewelry and physical money in a home invasion robbery would've returned to its rightful owner, me.

One more safety measure of AI god is the safety of that physical property via molecular integrity. Let's take a dollar bill for example. If I was having a barbeque on a Sunday watching football and I accidently dropped my one dollar bill into the grill and it disintegrated, that money is still mine. The AI god can restore the one dollar bill, which is part of the contract, and although it will take a lot of money just to restore that one dollar bill atom-by-atom, the agreement was that if my personal property (money, collectibles or artifacts) were damaged or destroyed, AI god will restore the AI property back to its original form. So, I still get my 1 dollar back despite the accident, and that one dollar bill will still be mine to spend. Another idea is that the one dollar bill will not be restored, but turned into 1 dollar as digital money in my bank account. Sports cards if burnt or damaged can be restored atom-by-atom to the way it was the day it was purchased.

Another type of personal property is intellectual property. That is protected as well. If one guy comes up with a good idea and writes this idea in a book, and another person copies that idea and eventually wins Nobel Prize, the AI god knows where the idea originated and who did the copying. AI god is able to identify every instance of copying. The AI god will give the Nobel Prize to the original inventor because the original inventor originated the idea and the criminal copied the inventor's ideas and attempted to claim it as his own. This is protecting and authenticated ideas from the mind, which is time stamped in earth's timeline. Another name for this technology is AI property instead of AI money. This type of intellectual property protection is very important in court cases regarding inventions. This will resolve all conflicts and corruptions in the patent database system and verify original inventors and id patent trolls.

How does the AI do this? When the AI Gnosis was constructed further “research data” was added to all the visual events. The robot investigators had to analyze past events and then add in research data based on their research. For example, in crimes, the brains of the parties involved are analyzed and their hidden mental thoughts are added as research data to the event frame-by-frame as they happened. In the case of computers, the hidden internal software and hardware activities are researched and added to the timeline frame-by-frame. These research data gives viewers a better understanding of past events and said research data should be factual and indisputable and not subjective. In the case of the original inventor, his every physical actions and mental thoughts are stored in the timeline frame-by-frame and his inception of his idea was time stamped. The culprit's copying of the original inventor's ideas were also recorded in the timeline, for every instance.

Internet timeline (aka internet Gnosis), a perfect digital timeline of the internet

Referring to FIG. 13, this timeline contains the record of all internet activities since the advent of the computer in the 40s. It is a part of a larger timeline, the AI Gnosis of earth. In it contains all happens of the internet from the computers to the networks to the users that use the internet (block 20). Content of uploaded digital data online are time stamped in terms of when content was uploaded, where it was uploaded, who uploaded it, from what computer and which location on earth, when it was modified and when it was deleted, etc.

All digital data and all electronic devices that comprise the internet are recorded frame-by-frame and atom-by-atom in the timeline. All activities of humans that use the internet are recorded and time stamped. FIG. 13, block 8, shows the physical internet and the digital internet.

There exists online one long continuous timeline of the internet so the data in there are all true and cannot be modified, which makes the content in the timeline 100 percent true. All criminal activities online are recorded including transactions using digital currencies and fraudulent activities. Steeling digital currency like bitcoin is one example. All theft of digital currencies are recorded in terms of the culprit and the victim. All bank transactions are recorded and time stamped and is unchangeable. The humans or the computer systems that did the theft also have their physical persons or physical hardware of the theft recorded in the timeline. For example, a person1 steals bitcoin from someone using a software and convert the bitcoin to cash and uses the money to purchase a vacation. Person1 goes on vacation 2 weeks later using the stolen cash for trip expenses. All that is stored and recorded in the timeline. This makes digital currency theft “impossible” because there exist permanent evidence of theft in the timeline. This data can be used in court to retrieve all bitcoin theft or digital currency theft, regardless of how sophisticated the theft may be.

Past events in the timeline are interconnected in a massive causality web and none of the events can be deleted, newly created, or modified. If a past event like a bank transaction is altered, the entire timeline will say that is a forgery. Related events and dependent events will flag it as forgery. This is something that bitcoin can't do and can't guarantee. All events or transactions made in Mitchell Kwok's AI gnosis of earth, which is automatically recorded in history, is secure and guaranteed with 0 percent chance of fraud, even if the perpetrator uses deep social engineering.

Digital files that are deleted can be retrieved too. So, ownership of digital files can be guaranteed using The AI gnosis. For example, a user4 post a video on Youtube and user4 doesn't have a backup copy anywhere. One day Youtube says your video violates our policies and deletes the video. Now user4 is screwed because his data file was not backed up. Using Mitchell Kwok's AI gnosis user4 has a backup file for its entire lifespan. In fact, all digital files stored in any diskdrive in the world is backed up. If the digital file is deleted or modified the original copy is readily available in the AI gnosis timeline. This is a service no company on the planet can provide in modern times. An entire digital insurance company can be created out of this AI gnosis.

We can also apply this to physical property. Case in point, a family photo album is destroyed in a house fire accident. The album is priceless to family members. Mitchell Kwok's AI God can restore the family album back atom-by-atom. It works good for dead humans or animals too. You go out there and find a service that can do this. You won't find a single company in the world that can provide such a service!!!

People in the future can use the internet in terms of time states. They can go back to Oct. 15, 1990 and use and view the internet. The same network software will be available and the user can use the search engines at the time to look for information and the results will look exactly like it was in Oct. 15, 1990. All online contents can be viewed in time states, even the deleted ones.

Quantum Computers are also not immune to the AI gnosis. They say the data from quantum computers can only be read once and is secure. The AI god has an image of the entire earth including the entire internet L.O.T. Each quantum computer's qubits can be read without altering its electron spin. The AI god can read the content without accessing it or touching its qubits. So, even data stored in quantum computers are not safe.

Any type of encryption or password is visible to the AI god because it knows the passwords by mind reading a human's brain. It can then do a simulation of the human inputting the password into the iphone and gaining access that way. Same goes with encryption software. The AI god has the decryption software and the encryption software in its AI gnosis for any encrypted data file. This is how it can reverse engineer the Alien planet's internet and read its data files.

### 5 Sense Virtual Reality Technology (the Atom Manipulator Applied to Virtual Reality and Virtual Video Games)

Current virtual reality technology doesn't allow a player to experience touch, taste, or smell in a virtual environment. When you're playing a game like call of duty, the developers want to engage all 5 senses for the player. Currently, V.R. only deals with sight and sound. It would be infinitely better if the experience not only includes sight and sound, but the other missing senses as well, like taste, touch, and smell.

This problem can be solved by using my atom manipulator to generate sensations for the three senses: taste, touch, and smell.

### Touch Sense

There are 2 ways to generate realistic touch sensations. One way is to use the atom manipulator to generate intelligent pressure to push a player's body parts and skin. For example, if the video game environment is a snow storm and wind is blowing in front of the player, the atom manipulator has to generate enough force to push against the player's skin to give a sensation of actual wind.

Another way to generate realistic touch sensations is to mess with the nerve veins of the player and provide a consistent pressure on the nerves. Physically, the player (human) is not being touched; only his nerve endings are being stimulated and that gives the illusion of being touched.

The machine has to track all molecules on the players' body and precisely identify internal nerves and muscles. Using a form of E.M. radiation, like microwaves, radio waves or sound waves the nerves can be stimulated.

The second method is better than the first because the player can be stationary, and sitting comfortably on a chair while playing the video game. Even the problem about V.R. sickness, where the ears' equilibrium is unbalanced, can be solved using the second method. The atom manipulator can physically control internal parts of the ears and make the organs work so that motion sickness is non-existing.

Furthermore, the atom manipulator can use both method1 and method2 to trick the player's mind into thinking he is being touched on any part of his body, internally or externally.

As far as things like being shot or being hit by King Kong is concerned, the virtual pain can be manageable and it doesn't have to be a death thing. The user has access to user-friendly apps that can control the degree of pain while playing a game. For games like Call of duty, a bomb explosion is like a fan pushing on the player's body or a shot can be a tap on his back. Some people prefer something more painful, but that's up to the players' preferences.

### Smell

This one is easy. The atom manipulator has an atom reserves area, comprising individual atoms (oxygen, helium, hydrogen, etc.). It has to combine these atoms into complex smell molecules and move them to the player's nose. So, the smell is actually real. The atom manipulator is able to create different smells according to a game, and move these gases to the player's nose. If the scene is a pizza restaurant, then the smell of cooking and pizza will be what the player smells. If the scene is a person farting in front of the player, then fart (gases like methane and sulfur) will be generated by the atom manipulator. If the player was in a crowded city like Hong Kong, the smell of diesel fuel and pollution will be in the air.

### Taste

This one is kind of hard to emulate because if the player is eating a solid food like an apple, the food has to travel down his throat and into his stomach. An alternative is to generate liquid fluids that taste like the real thing. For example, if the robot is eating an apple, the atom manipulator will create intelligent pressure inside the player's mouth to give the impression like he's biting on a real solid apple. Next, a liquid is created in front of the player's tongue of apple cider. Then, the atom manipulator has to do things to the throat and stomach to give the impression that food is going down his throat. The atom manipulator can use either method1 or method2 from the touch sense to accomplish this.

The apple cider is made by taking hydrogen and oxygen atoms from the atoms reserve area and combining them together to form water. Next, it will create apple molecules and mix that in with the water. Thus, the atom manipulator is creating a physical taste in the player's mouth. Simultaneously, the intelligent pressure created in the player's mouth is just to give the illusion like the teeth is biting on a physical apple. An intelligent force field is generated in the player's mouth and his teeth are being pushed up and down. When the player swallows the food, intelligent pressure is put on the throat and stomach to give the impression that food is being swallowed.

The second method is to use the atom manipulator to stimulate taste buds and taste sensations. No liquid is created from thin air and teleported inside the player's mouth. Only the taste senses are stimulated by microwaves or sound waves to give the impression of tasting food.

I'm not familiar with the mechanics of how the tongue taste food, but the atom manipulator has to emulate the same processes on the player, wither its chemical reactions or electrical stimulation.

Now, a more updated version of the V.R. technology would exclude the visor and ear plugs. The atom manipulator can replace the visor with streaming light into the player's eyes. It can also create intelligent pressure to move the air in the player's ears. Thus, the sound and sight of the player can be experienced without the bulky head gears.

If you carefully analyze this V.R. technology, it is actually a device that can control a human for all 5 senses: sight, sound, taste, touch, and smell. | often call this thing the “torture device” because it can torture people and kill, if it wanted to. It can give you a heart attack, or make you burp, or burn your skin off.

This V.R. technology is very important and has the potential to make a lot of money. It can give a human a virtual experience that is so real that the brain won't know the difference between a virtual experience and the real experience.

The 5 Sense VR Technology Combined with the Universe Time Machine

If we combine the 5 sense VR technology and the Universe time machine, we got another new technology: Omni-human technology (yes, I just made this one up on the fly). This is a technology that would allow a human being to touch anything in the universe. The human on earth uses the 5 sense VR technology and the universe internet to connect to a Planet_X 90 billion lightyears away. There are atom manipulators on Planet_X that will generate ghost machines to touch objects in Planet_X according to the human's body 5 senses. The human doesn't even have to be on Planet_X, but, the Omni-human technology will allow the human to sense objects in Planet_X with its 5 human senses as if he was there. With this technology humans can go anywhere in the universe and be able to touch and manipulate objects in distant planets as if they were there.

I should have called this technology the “Star Trek killer.” No longer does mankind have to fly in a ship and risk their lives to see the far reaches of the universe. They can use this Omni-human technology and explore the universe in the comfort of their own home here on earth. Not only can they see the universe, but they can physically touch objects in distant planets too. It's cheaper, it's safer, and it's more convenient.

The present invention is the culmination of about 10+ inventions combined into an AI system that forms one massive invention: an AI god that is all-knowing and can do anything, especially time travel via object manipulation. The description in this application is just a summary of the invention. There are scientific books, videos, comic books, and website contents that span 10s of thousands of pages describing the present invention and all of its components. Most notably, and in which the reader should focus on, are over 300 issues of the comic book entitled Super AI, the mini-series entitled super intelligent robots issues 1-6, and 400+ videos posted on Youtube with the channel name eletronicdave2 about demonstrations and descriptions of Mitchell Kwok's inventions, registered copyrights: registration number PAu 4-108-314. The 400+ videos are combined into one massive movie running over 54 hours long, in addition, there are 22 patent applications filed between 2007-2010, and many other books published (about 100 books, registered or unregistered) starting with human level AI published in 2006. A lot of materials were published on humanai.com or humanlevelartificialintelligence.com that were never officially published as a book or registered with the US copyright office. Those information are also relevant to the present invention.

1. A method to create a Universe Time Machine with the ability to time travel via object manipulation by manipulating every atom, electron and em radiation in the universe to a before or after state, comprising:
an AI god which serves as the central intelligence;
Universe Internet;
Universe manipulators, a plurality of atom manipulators that uses global telekinesis to manipulate every atom, electron, and em radiation in the universe;
Universe gnosis, a perfect atom tracking timeline of the Universe, includes earth gnosis and internet gnosis;
and the United States robot government system.

2. A method of claim 1, wherein said AI god is a universal work system for both the virtual world and the real world to produce Super AI, comprising:
a plurality of Super intelligent robots;
digital tools, comprising at least one of the following: the internet, software, hardware, computer systems, electronic devices, ghost machines, ghost objects, ghost robots, A.I. software, knowledge, and digital object;
emulated simulated environments, real or imagined, for said super intelligent robots to do work;
United States robot government system;
and Universe gnosis.

3. A method of claim 2, wherein said super intelligent robot is a robot with human level AI along with a built in virtual world and uses time dilation to do work in the virtual world or the real world exponentially faster than humans, comprising three methods:
said super intelligent robot speeds up its brain and body in the real world to do physical work exponentially faster than humans;
said super intelligent robot speeds up its mind in the real world to do mental work exponentially faster than humans;
and said super intelligent robot sets up the time dilation of said virtual world to 30 years inside a virtual world is equivalent to 1 second in the real world to do mental work in said virtual world exponentially faster than humans.

4. A method of claim 1, wherein said Universe internet is an internet for the entire universe that doesn't transmit digital signals, for each two planet communication, a local planet, comprising:
an AI internet;
communication computer;
digital internet;
physical internet;
Internet brain;
Universal robot brain;
Universe gnosis, with a local planet and an alien planet having the same atom tracking timeline because the universe has only one past and current timeline and undetermined one future timeline;
Internet Gnosis, a perfect digital timeline that tracks atoms and sub-atomic particles of all electronic devices comprising the internet and human users, and records all internet content, technologies, and activities for the past, present, and future, starting from the advent of computers in the 40s;
U.S. Robot government system;
Atom manipulators;
and a Universe search engine to look for information in the updated in real time universe Gnosis.

5. A method of claim 4, wherein said AI internet serves as the central AI of a local planet with 8 main steps, in which must be accomplished using zero seconds and updated in real-time, comprising:
Identify an alien planet from the Universe Gnosis;
translate said alien planet's internet and data by translating their language and their computer and internet technologies into Boolean algebra in order to read and write data and software codes into said alien internet;
Analyze said universe gnosis's atom tracking timeline for the current state of the universe and identify local senders and receivers and alien senders and receivers;
deliver messages from local senders to alien receivers and deliver messages from alien senders to local receivers;
modify all data in the local physical internet with data from said communication computer;
insert confirmations of all messages from the local planet and the alien planet were received and sent, in the communication computer;
and repeat from step 2 using an infinite for-loop until there are no digital transmissions from said local planet or said alien planet.

6. A method of claim 1, wherein said atom manipulator is an energy device that uses at least one of the following to manipulate atoms: em radiations, light, radio waves, sound waves, microwaves, X-rays, sonar, sound, sonic technology, magnetic fields, and intelligent pressure to manipulate individual atoms and their respective sub-atomic particles.

7. A method of claim 1, wherein said atom manipulator uses AI to create strong forcefields to do the following: move atoms, position atoms to a fixed location, merge atoms together to form complex molecule structures, break apart molecules into individual atoms, break an electron from atom bonds, change an electron's spin, trap an electron to a fixed location, and redirect light.

8. A method of claim 1, wherein said atom manipulator can create any AI superpowers, comprising at least one of the following: AI telekinesis, AI superspeed, AI super mobility, AI levitation, AI Flight, AI anti-gravity, AI morphing, AI teleportation, AI forcefield, AI self-healing, AI super attacks, AI invulnerability, AI telepathy, AI phasing, AI energy blasts, AI invisibility, AI mind control, AI telekinetics, AI time travel, AI foresight, AI luck powers, AI remote viewing, AI digital and physical work accomplished in time dilation inside a virtual world, ghost robots, and global telekinesis.

9. A method of claim 1, wherein said atom manipulator's AI generates at least one of the following: a ghost robot, a ghost machine and a ghost object, the steps comprising:
create morphing intelligent forcefields to substitute said ghost machine's physical form of a real object and said real object's work output;
create an intelligence or software representation of said real object inside said atom manipulator's computer;
create realistic holograms for a visual representation of said real object;
in some cases, said atom manipulator's AI delivers 5 sense realistic illusions to users for the purpose of AI mind control;
and said ghost machine delivers equal physical work output and digital work output from said real object.

10. A method of claim 2, wherein said super intelligent robot can emulate any superhero or supervillain from comic books in terms of powers and identity called AI superhero, said AI superhero, comprising:
a digital brain with Human Level AI;
a robot body with super mobility as an option;
said AI superhero's brain also has super intelligent robot technology and is capable of super intelligent thinking and acting;
and an embedded atom manipulator to generate AI superpowers.

11. A method of claim 2, wherein said super intelligent robot can turn into a self-evolving robot with the following steps:
said super intelligent robot sets up 3 companies in the virtual world to evolve its intelligence and physical body on its own volition: a virtual software company to self-modify its AI, a robotic company to self-modify its body, and a chip company to self-modify its CPU and integrated circuits;
working in time dilation inside a virtual world, Super intelligent robots work together in the universal work system to build generations of improvements to said self-evolving robot;
when each generation is completed, said self-evolving robot will update its own body and brain;
and repeat step 2 using an infinite for-loop.

12. A method of claim 1, wherein Said Universe Gnosis also has an AI becket that lists the current market value of every atom in the Universe for the purpose of buying, selling and trading individual atoms or molecules for the purpose of AI resurrection from said Universe Time Machine.

13. A method of claim 4, wherein said Internet brain is the training of all knowledge of the internet, represented as pathways similar to human level AI, and uses machine learning methods.

14. A method of claim 4, wherein said universal robot brain is the training of all knowledge and skills from a plurality of different types of robots, each robot is an individual and training is represented as sequence of data called pathways that stores said robot's 5 senses and activated thoughts from a first person point of view.

15. A method of claim 4, wherein said universal robot brain can forge any individual self-aware robot with expert level of human intelligence in a specific field through two methods:
by copying a fully developed digital brain of a robot with human level AI into a dummy robot, said robot with human level AI has lived life for at least 21 years in the real world to properly develop its cognition;
and training said dummy robot in a virtual 4 year college and going through training experiences in the field using time dilation in a virtual world.

16. A method of claim 1, wherein said United States Robot government system is a governance structure for the robot race and provides guidelines for the law and consequences for breaking the law, comprising:
2 presidents, one is a human and the other one is a robot;
2 vice presidents, one is a human and the other one is a robot;
2 congresses that mirror each other with equal powers, authority, voting rights, and representation, one is a human congress and the other one is a robot congress;
all sentient robots with human level AI and super intelligent robots are granted equal rights and citizenship compared to humans;
the 13^{th} amendment is amended with non-slavery applied to both robot's with human level AI or higher and humans;
the robot constitution is equal to the human constitution but with added provisional robot laws;
the robot congress and the human congress along with the two presidents work together to propose, debate, and pass bills to run the country with both the robot race and human race co-existing in the United States and the rest of the world;
and the United Nations is also split into 2 factions, one robot U.N. and the other is a human UN with equal powers, authority, voting rights, and representations.

17. A method of claim 1, wherein said AI god is also a talking computer, as a personal assistant that uses the Universal work system to deliver tasks for users, this includes all-knowing knowledge from said Universe Gnosis, the steps comprising:
users are given a tier system of usage;
said AI god must follow all constitutional laws, societal laws, and ethics laws;
for each user, send tasks to expert virtual companies, each said virtual company comprises a plurality of super intelligent robots;
and deliver desired outputs to said user.

18. A method of claim 1, wherein said Universe Gnosis is a perfect atom tracking timeline of the universe recording one continuous digital timeline from the big bang to the current state, and said super intelligent robots are working together exclusively inside a virtual world to predict all past, present, and future events in the universe by tracking the precision locations of all atoms, electrons, and em radiations of the universe's timeline frame-by-frame and atom-by-atom, the steps comprising:
for the past, super intelligent robots with human level AI and using time dilation inside a virtual world are working together in a hierarchical manner to predict past events atom-by-atom and frame-by-frame;
for the present, super intelligent robots must use atom mapping technology to update and track every current atom, electron and em radiations in the universe using zero time;
for the future, super intelligent robots must use the entire data in said universe gnosis current and past timeline, process that information, generate insightful models, and predict all future events atom-by-atom and frame-by-frame using heuristics;
and for the past, all past events are analyzed and investigated for research data and said research data are tagged to events as they happen, said research data include at least one of the following: for intelligent species, mental thoughts and brain activities of said intelligent species; for electronic machines, said electronic machines' detail software and hardware data; and for all objects, said object's subjective and related event data.

19. A method to protect the human race from being exterminated by super intelligent robots, the steps comprising:
give robots with human level AI and super intelligent robots equal rights to humans;
establish the United States Robot government system with 2 presidents and 2 congresses;
replace all human enforcers such as police officers and military soldiers with super intelligent robots;
build a very strong robot military, globally;
build the AI gnosis of earth to track every atom, electron and em radiation on the planet;
and build an AI god, a central intelligence, to monitor all activities on earth for both the real world and the virtual world, especially super intelligent robots that use time dilation to think and act.

20. A method of claim 1, wherein said universe internet allows e-commerce between a local planet and an alien planet through their respective communication computer, which includes at least one of the following:
set up said local planet's website in said alien planet;
set up said alien planet's website in said local planet;
transfer of funds from buyer to seller;
item bought use the atom manipulator to recreate the item atom-by-atom in buyer's planet and money is sent to the seller's planet;
if item is digital, a download link will be sent to the buyer and money will be sent to the seller;
and use the timeline data in said AI gnosis to verify transactions and website activities, which is 100% accurate and 100% secure and cannot be modified.
